(19) United States
(12) Patent Application Publication
(10) Pub. No.: US 2018/0315060 A1
(43) Pub. Date: Nov. 1, 2018

(54) METHODS AND APPARATUS TO ESTIMATE MEDIA IMPRESSION FREQUENCY DISTRIBUTIONS

(71) Applicant: The Nielsen Company (US), LLC, New York, NY (US)

(72) Inventors: Michael Sheppard, Brooklyn, NY (US); Yi PengFei, Shanghai (CN); Jonathan Sullivan, Hurricane, UT (US); Peter Lipa, Tucson, AZ (US); Ludo Daemen, Duffel (BE)

(21) Appl. No.: 15/551,586

(22) PCT Filed: Dec. 16, 2016
(86) PCT No.: PCT/CN2016/110313

§ 371 Date: Aug. 16, 2017

(51) Int. Cl. G06Q 30/02; H04L 29/08

(52) U.S. Cl. CPC G06Q 30/0201; H04L 67/22; G06Q 30/0203

(57) ABSTRACT

Methods and apparatus to estimate media impression frequency distributions are disclosed. An example method includes logging a plurality of requests in a database, the plurality of requests obtained from a plurality of network communications from computing devices, the plurality of requests indicative of accesses to media at the computing devices. The method further includes obtaining a first impression frequency distribution from a database proprietor. The first impression frequency distribution corresponding to user-identified impressions of census impressions and exclusive of unidentified impressions of the census impressions. The user-identified impressions corresponding to user-identified individuals for whom first demographic information is stored by the database proprietor. The first impression frequency distribution including a plurality of impression frequency groups of user-identified audience sizes. The method further includes determining a second impression frequency distribution for the user-identified impressions and the unidentified impressions of the census impressions based on the first impression frequency distribution.

### FIELD OF THE DISCLOSURE

This disclosure relates generally to monitoring media and, more particularly, to methods and apparatus to estimate media impression frequency distributions.

### BACKGROUND

Traditionally, audience measurement entities determine audience exposure to media based on registered panel members. That is, an audience measurement entity enrolls people who consent to being monitored into a panel. The audience measurement entity then monitors those panel members to determine media (e.g., television programs or radio programs, movies, DVDs, advertisements, webpages, streaming media, etc.) exposed to those panel members. In this manner, the audience measurement entity can determine exposure measures for different media based on the collected media measurement data.

### BRIEF DESCRIPTION OF THE DRAWINGS

FIG. 1A illustrates an example communication flow diagram of an example manner in which an audience measurement entity (AME) and a database proprietor can collect impressions and demographic information based on a client device reporting impressions to the AME and the database proprietor.

FIG. 1B depicts an example system to collect impressions of media presented at mobile devices and to collect impression information from distributed database proprietors for associating with the collected impressions.

FIG. 2 is a block diagram illustrating an example implementation of the example impression frequency analyzer of FIGS. 1A and/or 1B to determine frequency distributions for media impressions.

FIG. 3 illustrates example one-dimensional impression information that may be collected by the example impression frequency analyzer of FIG. 2 from the example database proprietor of FIGS. 1A and/or 1B.

FIG. 4 illustrates example two-dimensional impression information that may be collected by the example impression frequency analyzer of FIG. 2 from the example database proprietor of FIGS. 1A and/or 1B.

FIG. 5 is an example table representing a user-identified probability distribution indicating the interrelationships of impression frequencies between two dimensions for user-identified data.

FIG. 6 is an example table to define a constraint matrix for the user-identified probability distribution represented in the table of FIG. 5.

FIG. 7 illustrates an example linear system relating the constraint matrix of FIG. 6 and the user-identified probability distribution of FIG. 5 to constraints defined by the example impression information of FIG. 4.

FIG. 8 is an example table representing a census probability distribution indicating the interrelationships of impression frequencies between two dimensions for census data.

FIG. 9 is an example table to define a constraint matrix for the census probability distribution represented in the table of FIG. 8.

FIGS. 10-14 are flowcharts representative of example machine readable instructions that may be executed to implement the example impression frequency analyzer of FIG. 2.

FIG. 15 is an example processor platform that may be used to execute the example instructions of FIGS. 10, 11, 12, 13, and/or 14 to implement the example impression frequency analyzer of FIG. 2 in accordance with the teachings of this disclosure.

### DETAILED DESCRIPTION

Techniques for monitoring user access to Internet resources such as web pages, advertisements and/or other media have evolved significantly over the years. At one point in the past, such monitoring was done primarily through server logs. In particular, entities serving media on the Internet would log the number of requests received for their media at their server. Basing Internet usage research on server logs is problematic for several reasons. For example, server logs can be tampered with either directly or via zombie programs which repeatedly request media from servers to increase the server log counts corresponding to the requested media. Secondly, media is sometimes retrieved once, cached locally and then repeatedly viewed from the local cache without involving the server in the repeat viewings. Server logs cannot track these views of cached media because reproducing locally cached media does not require re-requesting the media from a server. Thus, server logs are susceptible to both over-counting and under-counting errors.

The inventions disclosed in Blumenau, U.S. Pat. No. 6,102,637, fundamentally changed the way Internet monitoring is performed and overcame the limitations of the server side log monitoring techniques described above. For example, Blumenau disclosed a technique wherein Internet media to be tracked is tagged with beacon instructions. In particular, monitoring instructions are associated with the Hypertext Markup Language (HTML) of the media to be tracked. When a client requests the media, both the media and the beacon instructions are downloaded to the client. The beacon instructions are, thus, executed whenever the media is accessed, be it from a server or from a cache.

The beacon instructions cause monitoring data reflecting information about the access to the media (e.g., the occurrence of a media impression) to be sent from the client that downloaded the media to a monitoring entity. Typically, the monitoring entity is an audience measurement entity (AME) (e.g., any entity interested in measuring or tracking audience exposures to advertisements, media, and/or any other media) that did not provide the media to the client and who is a trusted third party for providing accurate usage statistics (e.g., The Nielsen Company, LLC). Advantageously, because the beaconing instructions are associated with the media and executed by the client browser whenever the media is accessed, the monitoring information is provided to the AME irrespective of whether the client is associated with a panelist of the AME.

It is useful, however, to link demographics and/or other user information to the monitoring information. To address this issue, the AME establishes a panel of users who have agreed to provide their demographic information and to have their Internet browsing activities monitored. When an individual joins the panel, they provide detailed information concerning their identity and demographics (e.g., gender, race, income, home location, occupation, etc.) to the AME. The AME sets a cookie on the panelist computer that enables the AME to identify the panelist whenever the panelist accesses tagged media and, thus, sends monitoring information to the AME.

Since most of the clients providing monitoring information from the tagged pages are not panelists and, thus, are unknown to the AME, it is necessary to use statistical methods to impute demographic information based on the data collected for panelists to the larger population of users providing data for the tagged media. However, panel sizes of AMEs remain small compared to the general population of users. Thus, a problem is presented as to how to increase panel sizes while ensuring the demographics data of the panel is accurate.

There are many database proprietors operating on the Internet. These database proprietors provide services (e.g., social networking services, email services, media access services, etc.) to large numbers of subscribers. In exchange for the provision of such services, the subscribers register with the proprietors. As part of this registration, the subscribers provide detailed demographic information. Examples of such database proprietors include social network providers such as Facebook, Myspace, Twitter, etc. These database proprietors set cookies on the computers of their subscribers to enable the database proprietors to recognize registered users when such registered users visit their websites.

Unlike traditional media measurement techniques in which AMEs rely solely on their own panel member data to collect demographics-based audience measurement, example methods, apparatus, and/or articles of manufacture disclosed herein enable an AME to share demographic information with other entities that operate based on user registration models. As used herein, a user registration model is a model in which users subscribe to services of those entities by creating an account and providing demographic-related information about themselves. Sharing of demographic information associated with registered users of database proprietors enables an AME to extend or supplement their panel data with substantially reliable demographics information from external sources (e.g., database proprietors), thus extending the coverage, accuracy, and/or completeness of their demographics-based audience measurements. Such access also enables the AME to monitor persons who would not otherwise have joined an AME panel. Any web service provider entity having a database identifying demographics of a set of individuals may cooperate with the AME. Such entities may be referred to as “database proprietors” and include entities such as wireless service carriers, mobile software/service providers, social medium sites (e.g., Facebook, Twitter, MySpace, etc.), online retailer sites (e.g., Amazon.com, Buy.com, etc.), multi-service sites (e.g., Yahoo!, Google, Experian, etc.), and/or any other Internet sites that collect demographic data of users and/or otherwise maintain user registration records.

The use of demographic information from disparate data sources (e.g., high-quality demographic information from the panels of an audience measurement entity and/or registered user data of web service providers) results in improved reporting effectiveness of metrics for both online and offline advertising campaigns. Example techniques disclosed herein use online registration data to identify demographics of users, and/or other user information, and use server impression counts, and/or other techniques to track quantities of impressions attributable to those users. An impression corresponds to a home or individual having been exposed to the corresponding media and/or advertisement. Thus, an impression represents a home or an individual having been exposed to an advertisement or media or group of advertisements or media. In Internet advertising, a quantity of impressions or impression count is the total number of times an advertisement or advertisement campaign has been accessed by a web population (e.g., including the number of times accessed as decreased by, for example, pop-up blockers and/or increased by, for example, retrieval from local cache memory).

While each exposure to media constitutes a separate impression, the number of times a particular home or individual is exposed to the media is referred to as the impression frequency or simply, frequency. Thus, if six people are exposed to a particular advertisement once and four others are exposed to the same advertisement twice, the impression frequency for the first six people would be 1 while the impression frequency for the latter four people would be 2. The total number of impressions for the particular advertisement can be derived by multiplying each frequency value by the number of individuals corresponding to that frequency to generate a product for each frequency, and summing the products. Thus, in the above example, the impression frequency of 1 multiplied by the 6 people plus the impression frequency of 2 multiplied by the 4 people results in 14 (1×6+2×4=14) total impressions for the advertisement.

While the total impression count for online media may be determined by an AME based on information collected from the execution of beacon instructions tagged to the media, this information is insufficient to determine the frequency distribution of the media impressions. For example, the monitored information collected directly by the AME typically corresponds to individual cookies stored on client devices reporting the information. Thus, the AME may be able to determine the cookie frequency (e.g., the number of times each cookie is associated with an impression of a particular advertisement, advertisement campaign, or other media). However, the cookie frequency does not necessarily correlate to impression frequency measured at the individual audience level because individuals often access media using multiple devices associated with different cookies. That is, an AME may determine that five different cookies are each associated with two impressions of a particular advertisement (i.e., the impression frequency for each cookie is 2). However, there is no way of knowing whether the five different cookies corresponding to five different people (corresponding to an impression frequency of 2 each), whether two of the cookies are associated with the same person (resulting in an impression frequency of 4 for that person), or some other distribution.

Just as database proprietors may share demographic information that matches collected cookie information of unique individuals to enable an AME to assess the demographic composition of an audience, examples disclosed herein take advantage of information from database proprietors to estimate the frequency distribution of media impressions at the individual audience level. A challenge with using the impression information provided by database proprietors is that the information is typically limited to summary statistics of the total number of unique audience members and the total number of impressions experienced by the audience members.

In some examples, the summary of the impression information may be broken down based on different impression frequencies. That is, in some examples, in addition to identifying the total number of impressions associated with a total number of unique individuals recognized by a database proprietor, the database proprietor may also provide the number of unique individuals or audience size associated with different frequencies of exposure to the media of interest. For example, the database proprietor may separately provide the number of unique individuals that were exposed to 1 impression (i.e., an impression frequency of 1), the number of unique individuals exposed to 2 impressions (i.e., an impression frequency of 2), the number of unique individuals exposed to 3 impressions (i.e., an impression frequency of 3), etc. In some examples, individuals exposed to different numbers of impressions (different frequencies) may be represented in a single group (e.g., individuals associated with an impression frequency ranging from 4 to 9 may be in one group and individuals associated with an impression frequency of 10 or higher may be in a separate group).

While a database proprietor may be able to match the cookies associated with a significant portion of individuals exposed to media, there is likely to be at least some individuals for whom demographic information is unavailable to the database proprietor. The inability of a database proprietor to recognize a person associated with a given impression may occur due to: (1) the person accessing the media giving rise to the impression has not provided his or her information to the database proprietor (e.g., the person is not registered with the database proprietor (e.g., Facebook) such that there is no record of the person at the database proprietor, the registration profile corresponding to the person is incomplete, the registration profile corresponding to the person has been flagged as suspect for possibly containing inaccurate information, etc.), (2) the person is registered with the database proprietor, but has not accessed the database proprietor using the specific device on which the impression occurs (e.g., the device is new to the person, the person only accesses the database proprietor using different devices, and/or a user identifier for the person is not available on the device on which the impression occurs), and/or (3) the person is registered with the database proprietor and has accessed the database proprietor using the device on which the impression occurs, but takes other active or passive measures (e.g., blocks or deletes cookies) that prevent the database proprietor from associating the device with the person. In some examples, a user identifier for a person is not available on a device on which an impression occurs because the device and/or application/software on the device is not a cookie-based device and/or application.

Where the database proprietor cannot identify the person associated with a particular media impression as reported to an AME, the database proprietor likewise cannot specify the frequency of media impressions associated with the person. Thus, the summary statistics provided by a database provider, including a frequency distribution of media impressions at the individual level, is limited to user-identified impressions corresponding to user-identified individuals (e.g., individuals identifiable by a database proprietor) to the exclusion of unidentified impressions associated with individuals whom the database proprietor is unable to uniquely identify.

Examples disclosed herein use impression frequency distribution information provided by a database proprietor associated with recognized individuals to estimate the census impression frequency distribution of the entire audience population based on census audience measurements. As used herein, the term “census” when used in the context of audience measurements refers to the audience measurements that account for all instances of media exposure by all individuals in the total population of a target market for the media being monitored. The term census may be contrasted with the term “user-identified” that, as used herein, refers to the media exposures that can be specifically matched to unique individuals identifiable by a database proprietor because such individuals are registered users of the services provided by the database proprietor. Thus, while a user-identified impression frequency distribution is a frequency distribution corresponding to individuals (users) identifiable by a database proprietor, a census impression frequency distribution is a frequency distribution that accounts for both individuals identifiable by the database proprietor and all other individuals not identifiable by the database proprietor. A simple linear scaling of the user-identified impression frequency data obtained from a database proprietor to a census population (as may be used to extrapolate demographic information) is unsuitable in the context of estimating impression frequency distributions because the frequency of media impressions corresponds to the actual number of individuals experiencing each impression frequency and not merely relative proportions of the population. More particularly, a linear scaling approach is unsuitable because it cannot guarantee that the total number of unique individuals in an estimated impression frequency distribution is less than the actual number of individuals in the total population of interest.

Accordingly, examples disclosed herein implement procedures based on the principle of minimum cross entropy from information theory to calculate the impression frequency distribution for a total population of interest. Entropy, in information theory, is used in the context of probability distributions. An impression frequency distribution directly corresponds to a probability distribution for different impression frequencies by multiplying the probability of a particular impression frequency by the total population being modelled. In other words, the probability that a person has had k exposures to media (i.e., an impression frequency of k) is equivalent to the proportion of people within a total population that have experienced k exposures to the media. Thus, an impression frequency distribution that refers to actual numbers of individuals and a probability distribution that refers to probability percentages may be used interchangeably with the difference being whether the total population of interest is taken into account.

This direct correspondence of probability distributions to impression frequency distributions advantageously enables the use of the principle of minimum cross entropy to estimate a census impression frequency distribution for a total population. More particularly, in some examples, the estimated census impression frequency distribution for a total population is determined to correspond to a census probability distribution P that satisfies the principle of minimum cross entropy between the census probability distribution P and a user-identified probability distribution Q consistent with constraints defined by known information (e.g., based on information provided by the database proprietor and/or that is otherwise available). In other words, the principle of minimum cross entropy seeks to determine a census probability distribution (P) that is as close as possible to the user-identified probability distribution (Q). The user-identified probability distribution Q serves as prior information in entropy terms. Each of the probability distributions P and Q define the probability that a person within a population of target market for media being monitored is exposed to the media any given number of times (i.e., any given impression frequency). However, P and Q are not the same. The user-identified probability distribution Q represents the probability of different impression frequencies based exclusively on impressions that can be matched to identifiable individuals by a database proprietor. By contrast, the census probability distribution P represents the probability of different impression frequencies corresponding to all media impressions whether associated with identifiable individuals or not.

In some examples, the user-identified probability distribution Q directly corresponds to the user-identified impression frequency distribution provided by a database proprietor. For example, the database proprietor may provide the audience size of user-identified individuals corresponding to each of a range of impression frequencies (e.g., 1, 2, 3, 5, etc.). By dividing the number of user-identified individuals for each discrete impression frequency by a total population of interest, the percentage of people from the total population associated with each impression frequency can be determined and used as the probability for that impression frequency. The total population is a known parameter determined based on the target market in which the media being monitored is distributed. For example, if an advertising campaign was run in a specific city, the total population of interest would be the entire population of the city. In some examples, the probability of a person in the population not experiencing any media impressions (i.e., an impression frequency of 0) may be determined as the proportion of people from the total population that are not accounted for in the user-identified impression frequency data provided by the database proprietor.

In some examples, the user-identified impression frequency data provided by the database proprietor may not provide information for every impression frequency of interest. For example, the database proprietor may combine the individuals associated with the impression frequencies 5 through 10 into a single group for reporting to an AME. In such examples, the probability for each individual impression frequency within the specified range reported by the database proprietor may be estimated by satisfying the principle of maximum entropy subject to constraints defined by known information. Briefly stated, the principle of maximum entropy provides that, subject to prior information, the probability distribution that best represents known information is the distribution with the largest information entropy.

Additionally or alternatively, in some examples, database proprietors may provide multi-dimensional impression frequency distribution data. In some examples, the different dimensions correspond to different platforms (e.g., personal computer (PC), mobile, tablet, etc.) of the media devices used to access the media, different sites (e.g., Internet domains) in which the media is provided, different formats for the media (e.g., a banner ad, a popup ad, a floating ad, etc.), different placements of the media on a user interface or webpage (e.g., in the header section of a website, in a sidebar, etc.), different geographic locations (e.g., designated market area) in which the media is accessed, different demographics, and/or any other metric by which the census-wide data may be divided into more granular portions. In a multi-dimensional case, the database proprietor may provide separate impression frequency distribution data for each dimension but provide limited information about the interactions or interrelationships between the different dimensions (e.g., the number of unique individuals exposed to media X number of times via a PC device and Y number of times via a mobile device). In such examples, the user-identified probability distribution Q used in the cross entropy calculation is first solved to account for the interrelationships of the different dimensions by satisfying the principle of maximum entropy. Once the user-identified probability distribution Q is solved for, it can be used as prior information for the minimum cross entropy calculation described above to solve for a census probability distribution P corresponding to an entire population of interest for the media being monitored.

Once the census probability distribution P for media is known, the impression frequency distribution for the media can be estimated to predict the number of impressions at any particular impression frequency and/or the audience size associated with the particular impression frequency. Furthermore, for multi-dimensional data, any combination of interactions between the different dimensions can be analyzed to predict relevant audience sizes and/or impression counts at particular impression frequencies. Further still, the total number of individuals associated with census impressions can be determined to assess the actual size of the audience of the media of interest.

An example media monitoring device of an audience measurement entity includes an impression information collector to: obtain requests from computing devices indicative of accesses to media at the computing devices, a total count of the requests corresponding to a total number of census impressions associated with the media; and obtain a first impression frequency distribution from a database proprietor, the first impression frequency distribution corresponding to user-identified impressions of the census impressions and exclusive of unidentified impressions of the census impressions, the user-identified impressions corresponding to user-identified individuals for whom first demographic information is stored by the database proprietor (e.g., persons identifiable by the database proprietor), the first impression frequency distribution including a plurality of impression frequency groups of user-identified audience sizes, ones of the impression frequency groups representative of user-identified individuals that accessed the media a corresponding number numbers of times. The processor to also implement a user-identified impression frequency data analyzer to determine a second impression frequency distribution for the user-identified impressions and the unidentified impressions of the census impressions based on the first impression frequency distribution.

An example method includes logging a plurality of requests in a database, the plurality of requests obtained from a plurality of network communications from computing devices, the plurality of requests indicative of accesses to media at the computing devices, a total count of the requests corresponding to a total number of census impressions associated with the media. The example method further includes obtaining a first impression frequency distribution from a database proprietor, the first impression frequency distribution corresponding to user-identified impressions of the census impressions and exclusive of unidentified impressions of the census impressions, the user-identified impressions corresponding to user-identified individuals for whom first demographic information is stored by the database proprietor (e.g., persons identifiable by the database proprietor), the first impression frequency distribution including a plurality of impression frequency groups of user-identified audience sizes, ones of the impression frequency groups representative of user-identified individuals that accessed the media a corresponding number numbers of times. The example method also includes determining, using the processor, a second impression frequency distribution for the user-identified impressions and the unidentified impressions of the census impressions based on the first impression frequency distribution.

An example tangible computer readable storage medium includes example instructions that, when executed, cause a machine to log a plurality of requests in a database, the plurality of requests obtained from a plurality of network communications from computing devices, the plurality of requests indicative of accesses to media at the computing devices, a total count of the requests corresponding to a total number of census impressions associated with the media. The instructions further cause the machine to obtain a first impression frequency distribution from a database proprietor, the first impression frequency distribution corresponding to user-identified impressions of the census impressions and exclusive of unidentified impressions of the census impressions, the user-identified impressions corresponding to user-identified individuals for whom first demographic information is stored by the database proprietor (e.g., persons identifiable by the database proprietor), the first impression frequency distribution including a plurality of impression frequency groups of user-identified audience sizes, ones of the impression frequency groups representative of user-identified individuals that accessed the media a corresponding number numbers of times. The instructions further cause the media monitoring device to determine a second impression frequency distribution for the user-identified impressions and the unidentified impressions of the census impressions based on the first impression frequency distribution.

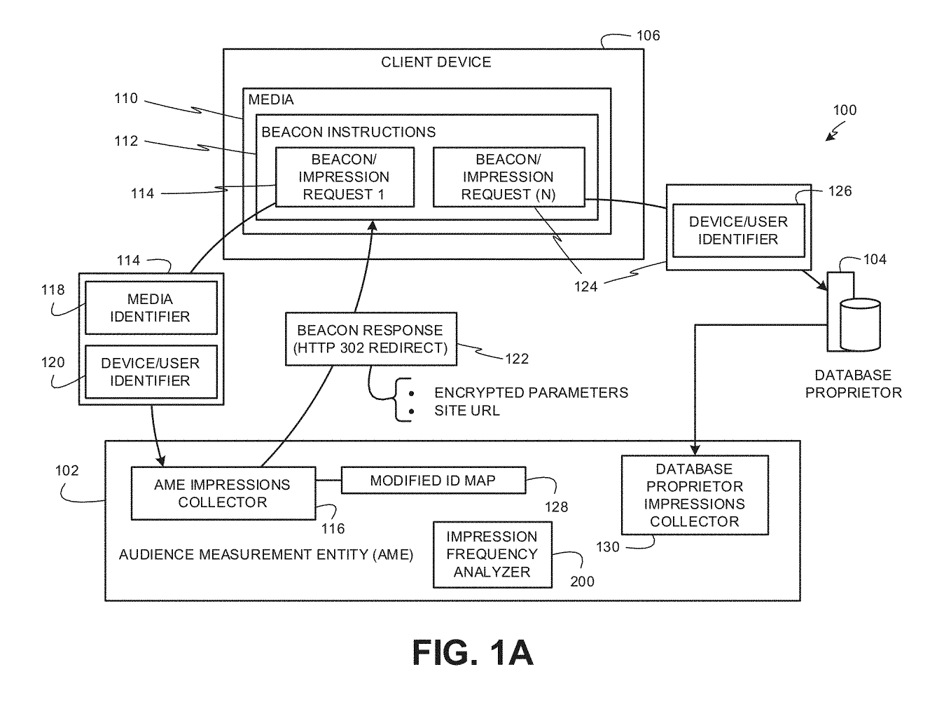

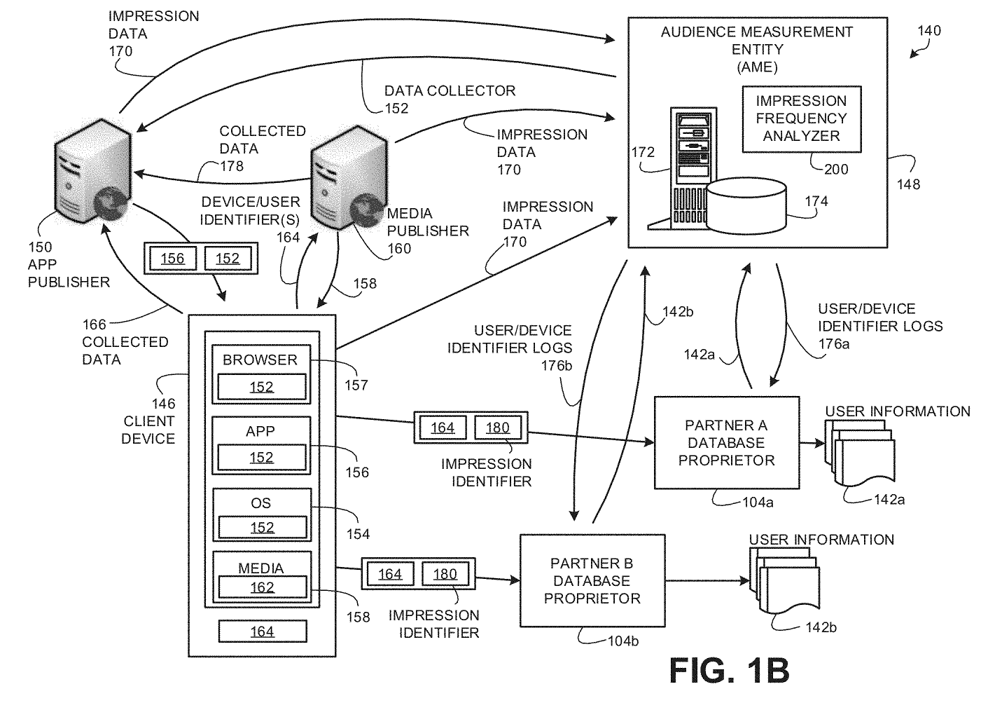

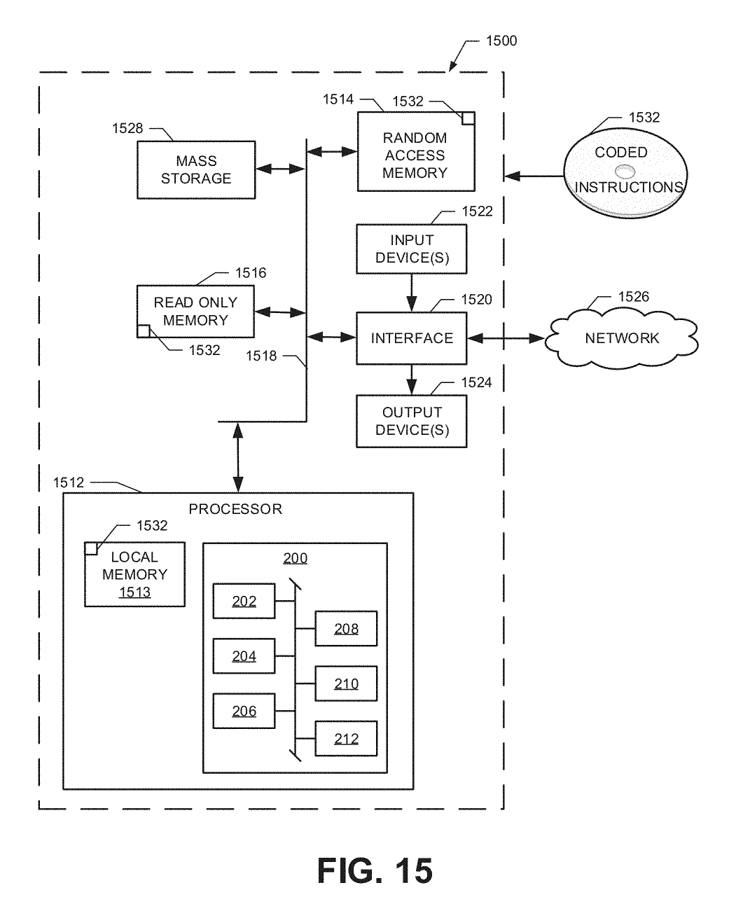

FIG. 1A is an example communication flow diagram 100 of an example manner in which an audience measurement entity (AME) 102 and a database proprietor 104 can collect demographic impressions based on client devices 106 reporting impressions to the AME 102 and the database proprietor 104. In some examples, the AME 102 includes an example impression frequency analyzer 200 to be implemented by a computer/processor system (e.g., the processor system 1500 of FIG. 15) that may analyze the collected impression data to determine frequency distributions for media impressions as described more fully below. Demographic impressions refer to impressions that can be associated with particular individuals for whom specific demographic information is known. The example chain of events shown in FIG. 1A occurs when a client device 106 accesses media for which the client device 106 reports an impression to the AME 102 and the database proprietor 104. In some examples, the client device 106 reports impressions for accessed media based on instructions (e.g., beacon instructions) embedded in the media that instruct the client device 106 (e.g., instruct a web browser or an app in the client device 106) to send beacon/impression requests to the AME 102 and/or the database proprietor 104. In such examples, the media having the beacon instructions is referred to as tagged media. In other examples, the client device 106 reports impressions for accessed media based on instructions embedded in apps or web browsers that execute on the client device 106 to send beacon/impression requests to the AME 102 and/or the database proprietor 104 for corresponding media accessed via those apps or web browsers. In any case, the beacon/impression requests include device/user identifiers (IDs) (e.g., AME IDs and/or database proprietor IDs) as described further below to allow the corresponding AME 102 and/or the corresponding database proprietor 104 to associate demographic information with resulting logged impressions.

In the illustrated example, the client device 106 accesses media 110 that is tagged with the beacon instructions 112. The beacon instructions 112 cause the client device 106 to send a beacon/impression request 114 to an AME impressions collector 116 when the client device 106 accesses the media 110. For example, a web browser and/or app of the client device 106 executes the beacon instructions 112 in the media 110 which instruct the browser and/or app to generate and send the beacon/impression request 114. In the illustrated example, the client device 106 sends the beacon/impression request 114 using an HTTP (hypertext transfer protocol) request addressed to the URL (uniform resource locator) of the AME impressions collector 116 at, for example, a first internet domain of the AME 102. The beacon/impression request 114 of the illustrated example includes a media identifier 118 (e.g., an identifier that can be used to identify content, an advertisement, and/or any other media) corresponding to the media 110. In some examples, the beacon/impression request 114 also includes a site identifier (e.g., a URL) of the website that served the media 110 to the client device 106 and/or a host website ID (e.g., www.acme.com) of the website that displays or presents the media 110. In the illustrated example, the beacon/impression request 114 includes a device/user identifier 120. In the illustrated example, the device/user identifier 120 that the client device 106 provides to the AME impressions collector 116 in the beacon impression request 114 is an AME ID because it corresponds to an identifier that the AME 102 uses to identify a panelist corresponding to the client device 106. In other examples, the client device 106 may not send the device/user identifier 120 until the client device 106 receives a request for the same from a server of the AME 102 in response to, for example, the AME impressions collector 116 receiving the beacon/impression request 114.

In some examples, the device/user identifier 120 may be a device identifier (e.g., an international mobile equipment identity (IMEI), a mobile equipment identifier (MEID), a media access control (MAC) address, etc.), a web browser unique identifier (e.g., a cookie), a user identifier (e.g., a user name, a login ID, etc.), an Adobe Flash® client identifier, identification information stored in an HTML5 datastore, and/or any other identifier that the AME 102 stores in association with demographic information about users of the client devices 106. In this manner, when the AME 102 receives the device/user identifier 120, the AME 102 can obtain demographic information corresponding to a user of the client device 106 based on the device/user identifier 120 that the AME 102 receives from the client device 106. In some examples, the device/user identifier 120 may be encrypted (e.g., hashed) at the client device 106 so that only an intended final recipient of the device/user identifier 120 can decrypt the hashed identifier 120. For example, if the device/user identifier 120 is a cookie that is set in the client device 106 by the AME 102, the device/user identifier 120 can be hashed so that only the AME 102 can decrypt the device/user identifier 120. If the device/user identifier 120 is an IMEI number, the client device 106 can hash the device/user identifier 120 so that only a wireless carrier (e.g., the database proprietor 104) can decrypt the hashed identifier 120 to recover the IMEI for use in accessing demographic information corresponding to the user of the client device 106. By hashing the device/user identifier 120, an intermediate party (e.g., an intermediate server or entity on the Internet) receiving the beacon request cannot directly identify a user of the client device 106.

In response to receiving the beacon/impression request 114, the AME impressions collector 116 logs an impression for the media 110 by storing the media identifier 118 contained in the beacon/impression request 114. In the illustrated example of FIG. 1A, the AME impressions collector 116 also uses the device/user identifier 120 in the beacon/impression request 114 to identify AME panelist demographic information corresponding to a panelist of the client device 106. That is, the device/user identifier 120 matches a user ID of a panelist member (e.g., a panelist corresponding to a panelist profile maintained and/or stored by the AME 102). In this manner, the AME impressions collector 116 can associate the logged impression with demographic information of a panelist corresponding to the client device 106.

In some examples, the beacon/impression request 114 may not include the device/user identifier 120 if, for example, the user of the client device 106 is not an AME panelist. In such examples, the AME impressions collector 116 logs impressions regardless of whether the client device 106 provides the device/user identifier 120 in the beacon/impression request 114 (or in response to a request for the identifier 120). When the client device 106 does not provide the device/user identifier 120, the AME impressions collector 116 will still benefit from logging an impression for the media 110 even though it will not have corresponding demographics. For example, the AME 102 may still use the logged impression to generate a total impressions count and/or a frequency of impressions (e.g., an impressions frequency) for the media 110. Additionally or alternatively, the AME 102 may obtain demographics information from the database proprietor 104 for the logged impression if the client device 106 corresponds to a subscriber of the database proprietor 104.

In the illustrated example of FIG. 1A, to compare or supplement panelist demographics (e.g., for accuracy or completeness) of the AME 102 with demographics from one or more database proprietors (e.g., the database proprietor 104), the AME impressions collector 116 returns a beacon response message 122 (e.g., a first beacon response) to the client device 106 including an HTTP “302 Found” re-direct message and a URL of a participating database proprietor 104 at, for example, a second internet domain. In the illustrated example, the HTTP “302 Found” re-direct message in the beacon response 122 instructs the client device 106 to send a second beacon request 124 to the database proprietor 104. In other examples, instead of using an HTTP “302 Found” re-direct message, redirects may be implemented using, for example, an iframe source instruction (e.g., <iframe src=“ ”>) or any other instruction that can instruct a client device to send a subsequent beacon request (e.g., the second beacon request 124) to a participating database proprietor 104. In the illustrated example, the AME impressions collector 116 determines the database proprietor 104 specified in the beacon response 122 using a rule and/or any other suitable type of selection criteria or process. In some examples, the AME impressions collector 116 determines a particular database proprietor to which to redirect a beacon request based on, for example, empirical data indicative of which database proprietor is most likely to have demographic data for a user corresponding to the device/user identifier 120. In some examples, the beacon instructions 112 include a predefined URL of one or more database proprietors to which the client device 106 should send follow up beacon requests 124. In other examples, the same database proprietor is always identified in the first redirect message (e.g., the beacon response 122).

In the illustrated example of FIG. 1A, the beacon/impression request 124 may include a device/user identifier 126 that is a database proprietor ID because it is used by the database proprietor 104 to identify a subscriber of the client device 106 when logging an impression. In some instances (e.g., in which the database proprietor 104 has not yet set a database proprietor ID in the client device 106), the beacon/impression request 124 does not include the device/user identifier 126. In some examples, the database proprietor ID is not sent until the database proprietor 104 requests the same (e.g., in response to the beacon/impression request 124). In some examples, the device/user identifier 126 is a device identifier (e.g., an international mobile equipment identity (IMEI), a mobile equipment identifier (MEID), a media access control (MAC) address, etc.), a web browser unique identifier (e.g., a cookie), a user identifier (e.g., a user name, a login ID, etc.), an Adobe Flash® client identifier, identification information stored in an HTML5 datastore, and/or any other identifier that the database proprietor 104 stores in association with demographic information about subscribers corresponding to the client devices 106. When the database proprietor 104 receives the device/user identifier 126, the database proprietor 104 can obtain demographic information corresponding to a user of the client device 106 based on the device/user identifier 126 that the database proprietor 104 receives from the client device 106. In some examples, the device/user identifier 126 may be encrypted (e.g., hashed) at the client device 106 so that only an intended final recipient of the device/user identifier 126 can decrypt the hashed identifier 126. For example, if the device/user identifier 126 is a cookie that is set in the client device 106 by the database proprietor 104, the device/user identifier 126 can be hashed so that only the database proprietor 104 can decrypt the device/user identifier 126. If the device/user identifier 126 is an IMEI number, the client device 106 can hash the device/user identifier 126 so that only a wireless carrier (e.g., the database proprietor 104) can decrypt the hashed identifier 126 to recover the IMEI for use in accessing demographic information corresponding to the user of the client device 106. By hashing the device/user identifier 126, an intermediate party (e.g., an intermediate server or entity on the Internet) receiving the beacon request cannot directly identify a user of the client device 106. For example, if the intended final recipient of the device/user identifier 126 is the database proprietor 104, the AME 102 cannot recover identifier information when the device/user identifier 126 is hashed by the client device 106 for decrypting only by the intended database proprietor 104.

Although only a single database proprietor 104 is shown in FIG. 1A, the impression reporting/collection process of FIG. 1A may be implemented using multiple database proprietors. In some such examples, the beacon instructions 112 cause the client device 106 to send beacon/impression requests 124 to numerous database proprietors. For example, the beacon instructions 112 may cause the client device 106 to send the beacon/impression requests 124 to the numerous database proprietors in parallel or in daisy chain fashion. In some such examples, the beacon instructions 112 cause the client device 106 to stop sending beacon/impression requests 124 to database proprietors once a database proprietor has recognized the client device 106. In other examples, the beacon instructions 112 cause the client device 106 to send beacon/impression requests 124 to database proprietors so that multiple database proprietors can recognize the client device 106 and log a corresponding impression. In any case, multiple database proprietors are provided the opportunity to log impressions and provide corresponding demographics information if the user of the client device 106 is a subscriber of services of those database proprietors.

In some examples, prior to sending the beacon response 122 to the client device 106, the AME impressions collector 116 replaces site IDs (e.g., URLs) of media provider(s) that served the media 110 with modified site IDs (e.g., substitute site IDs) which are discernable only by the AME 102 to identify the media provider(s). In some examples, the AME impressions collector 116 may also replace a host website ID (e.g., www.acme.com) with a modified host site ID (e.g., a substitute host site ID) which is discernable only by the AME 102 as corresponding to the host website via which the media 110 is presented. In some examples, the AME impressions collector 116 also replaces the media identifier 118 with a modified media identifier 118 corresponding to the media 110. In this way, the media provider of the media 110, the host website that presents the media 110, and/or the media identifier 118 are obscured from the database proprietor 104, but the database proprietor 104 can still log impressions based on the modified values which can later be deciphered by the AME 102 after the AME 102 receives logged impressions from the database proprietor 104. In some examples, the AME impressions collector 116 does not send site IDs, host site IDS, the media identifier 118 or modified versions thereof in the beacon response 122. In such examples, the client device 106 provides the original, non-modified versions of the media identifier 118, site IDs, host IDs, etc. to the database proprietor 104.

In the illustrated example, the AME impression collector 116 maintains a modified ID mapping table 128 that maps original site IDs with modified (or substitute) site IDs, original host site IDs with modified host site IDs, and/or maps modified media identifiers to the media identifiers such as the media identifier 118 to obfuscate or hide such information from database proprietors such as the database proprietor 104. Also in the illustrated example, the AME impressions collector 116 encrypts all of the information received in the beacon/impression request 114 and the modified information to prevent any intercepting parties from decoding the information. The AME impressions collector 116 of the illustrated example sends the encrypted information in the beacon response 122 to the client device 106 so that the client device 106 can send the encrypted information to the database proprietor 104 in the beacon/impression request 124. In the illustrated example, the AME impressions collector 116 uses an encryption that can be decrypted by the database proprietor 104 site specified in the HTTP “302 Found” re-direct message.

Periodically or aperiodically, the impression data collected by the database proprietor 104 is provided to a database proprietor impressions collector 130 of the AME 102 as, for example, batch data. In some examples, the impression data may be combined or aggregated to generate a media impression frequency distribution for all individuals exposed to the media 110 that the database proprietor 104 was able to identify (e.g., based on the device/user identifier 126). During a data collecting and merging process to combine demographic and impression data from the AME 102 and the database proprietor(s) 104, impressions logged by the AME 102 for the client devices 106 that do not have a database proprietor ID will not correspond to impressions logged by the database proprietor 104 because the database proprietor 104 typically does not log impressions for the client devices that do not have database proprietor IDs.

Additional examples that may be used to implement the beacon instruction processes of FIG. 1A are disclosed in Mainak et al., U.S. Pat. No. 8,370,489, which is hereby incorporated herein by reference in its entirety. In addition, other examples that may be used to implement such beacon instructions are disclosed in Blumenau, U.S. Pat. No. 6,108,637, which is hereby incorporated herein by reference in its entirety.

FIG. 1B depicts an example system 142 to collect impression information based on user information 142a, 142b from distributed database proprietors 104 (designated as 104a and 104b in FIG. 1B) for associating with impressions of media presented at a client device 146. In the illustrated examples, user information 142a, 142b or user data includes one or more of demographic data, purchase data, and/or other data indicative of user activities, behaviors, and/or preferences related to information accessed via the Internet, purchases, media accessed on electronic devices, physical locations (e.g., retail or commercial establishments, restaurants, venues, etc.) visited by users, etc. Thus, the user information 142a, 142b may indicate and/or be analyzed to determine the impression frequency of individual users with respect to different media accessed by the users. In some examples, such impression information may be combined or aggregated to generate a media impression frequency distribution for all users exposed to particular media for whom the database proprietor has particular user information 142a, 142b. More particularly, in the illustrated example, the AME 102 includes the example impression frequency analyzer 200 analyze the collected impression data to determine frequency distributions for media impressions as described more fully below.

In the illustrated example of FIG. 1B, the client device 146 may be a mobile device (e.g., a smart phone, a tablet, etc.), an internet appliance, a smart television, an internet terminal, a computer, or any other device capable of presenting media received via network communications. In some examples, to track media impressions on the client device 146, an audience measurement entity (AME) 102 partners with or cooperates with an app publisher 150 to download and install a data collector 152 on the client device 146. The app publisher 150 of the illustrated example may be a software app developer that develops and distributes apps to mobile devices and/or a distributor that receives apps from software app developers and distributes the apps to mobile devices. The data collector 152 may be included in other software loaded onto the client device 146, such as the operating system 154, an application (or app) 156, a web browser 117, and/or any other software.

Any of the example software 154, 156, 117 may present media 158 received from a media publisher 160. The media 158 may be an advertisement, video, audio, text, a graphic, a web page, news, educational media, entertainment media, or any other type of media. In the illustrated example, a media ID 162 is provided in the media 158 to enable identifying the media 158 so that the AME 102 can credit the media 158 with media impressions when the media 158 is presented on the client device 146 or any other device that is monitored by the AME 102.

The data collector 152 of the illustrated example includes instructions (e.g., Java, java script, or any other computer language or script) that, when executed by the client device 146, cause the client device 146 to collect the media ID 162 of the media 158 presented by the app program 156, the browser 117, and/or the client device 146, and to collect one or more device/user identifier(s) 164 stored in the client device 146. The device/user identifier(s) 164 of the illustrated example include identifiers that can be used by corresponding ones of the partner database proprietors 104a-b to identify the user or users of the client device 146, and to locate user information 142a-b corresponding to the user(s). For example, the device/user identifier(s) 164 may include hardware identifiers (e.g., an international mobile equipment identity (IMEI), a mobile equipment identifier (MEID), a media access control (MAC) address, etc.), an app store identifier (e.g., a Google Android ID, an Apple ID, an Amazon ID, etc.), a unique device identifier (UDID) (e.g., a non-proprietary UDID or a proprietary UDID such as used on the Microsoft Windows platform), an open source unique device identifier (OpenUDID), an open device identification number (ODIN), a login identifier (e.g., a username), an email address, user agent data (e.g., application type, operating system, software vendor, software revision, etc.), an Ad-ID (e.g., an advertising ID introduced by Apple, Inc. for uniquely identifying mobile devices for the purposes of serving advertising to such mobile devices), an Identifier for Advertisers (IDFA) (e.g., a unique ID for Apple iOS devices that mobile ad networks can use to serve advertisements), a Google Advertising ID, a Roku ID (e.g., an identifier for a Roku OTT device), third-party service identifiers (e.g., advertising service identifiers, device usage analytics service identifiers, demographics collection service identifiers), web storage data, document object model (DOM) storage data, local shared objects (also referred to as “Flash cookies”), etc. In examples in which the media 158 is accessed using an application and/or browser (e.g., the app 156 and/or the browser 117) that do not employ cookies, the device/user identifier(s) 164 are non-cookie identifiers such as the example identifiers noted above. In examples in which the media 158 is accessed using an application or browser that does employ cookies, the device/user identifier(s) 164 may additionally or alternatively include cookies. In some examples, fewer or more device/user identifier(s) 164 may be used. In addition, although only two partner database proprietors 104a-b are shown in FIG. 1, the AME 102 may partner with any number of partner database proprietors to collect distributed user information (e.g., the user information 142a-b).

In some examples, the client device 146 may not allow access to identification information stored in the client device 146. For such instances, the disclosed examples enable the AME 102 to store an AME-provided identifier (e.g., an identifier managed and tracked by the AME 102) in the client device 146 to track media impressions on the client device 146. For example, the AME 102 may provide instructions in the data collector 152 to set an AME-provided identifier in memory space accessible by and/or allocated to the app program 156 and/or the browser 117, and the data collector 152 uses the identifier as a device/user identifier 164. In such examples, the AME-provided identifier set by the data collector 152 persists in the memory space even when the app program 156 and the data collector 152 and/or the browser 117 and the data collector 152 are not running. In this manner, the same AME-provided identifier can remain associated with the client device 146 for extended durations. In some examples in which the data collector 152 sets an identifier in the client device 146, the AME 102 may recruit a user of the client device 146 as a panelist, and may store user information collected from the user during a panelist registration process and/or collected by monitoring user activities/behavior via the client device 146 and/or any other device used by the user and monitored by the AME 102. In this manner, the AME 102 can associate user information of the user (from panelist data stored by the AME 102) with media impressions attributed to the user on the client device 146. As used herein, a panelist is a user registered on a panel maintained by a ratings entity (e.g., the AME 102) that monitors and estimates audience exposure to media.

In the illustrated example, the data collector 152 sends the media ID 162 and the one or more device/user identifier(s) 164 as collected data 166 to the app publisher 150. Alternatively, the data collector 152 may be configured to send the collected data 166 to another collection entity (other than the app publisher 150) that has been contracted by the AME 102 or is partnered with the AME 102 to collect media ID's (e.g., the media ID 162) and device/user identifiers (e.g., the device/user identifier(s) 164) from user devices (e.g., the client device 146). In the illustrated example, the app publisher 150 (or a collection entity) sends the media ID 162 and the device/user identifier(s) 164 as impression data 170 to an impression collector 172 (e.g., an impression collection server or a data collection server) at the AME 102. The impression data 170 of the illustrated example may include one media ID 162 and one or more device/user identifier(s) 164 to report a single impression of the media 158, or it may include numerous media ID's 162 and device/user identifier(s) 164 based on numerous instances of collected data (e.g., the collected data 166) received from the client device 146 and/or other devices to report multiple impressions of media.

In the illustrated example, the impression collector 172 stores the impression data 170 in an AME media impressions store 174 (e.g., a database or other data structure). Subsequently, the AME 102 sends the device/user identifier(s) 164 to corresponding partner database proprietors (e.g., the partner database proprietors 104a-b) to receive user information (e.g., the user information 142a-b) corresponding to the device/user identifier(s) 164 from the partner database proprietors 104a-b so that the AME 102 can associate the user information with corresponding media impressions of media (e.g., the media 158) presented at the client device 146.

More particularly, in some examples, after the AME 102 receives the device/user identifier(s) 164, the AME 102 sends device/user identifier logs 176a-b to corresponding partner database proprietors (e.g., the partner database proprietors 104a-b). Each of the device/user identifier logs 176a-b may include a single device/user identifier 164, or it may include numerous aggregate device/user identifiers 164 received over time from one or more devices (e.g., the client device 146). After receiving the device/user identifier logs 176a-b, each of the partner database proprietors 104a-b looks up its users corresponding to the device/user identifiers 164 in the respective logs 176a-b. In this manner, each of the partner database proprietors 104a-b collects user information 142a-b corresponding to users identified in the device/user identifier logs 176a-b for sending to the AME 102. For example, if the partner database proprietor 104a is a wireless service provider and the device/user identifier log 176a includes IMEI numbers recognizable by the wireless service provider, the wireless service provider accesses its subscriber records to find users having IMEI numbers matching the IMEI numbers received in the device/user identifier log 176a. When the users are identified, the wireless service provider copies the users' user information to the user information 142a for delivery to the AME 102.

In some other examples, the data collector 152 is configured to collect the device/user identifier(s) 164 from the client device 146. The example data collector 152 sends the device/user identifier(s) 164 to the app publisher 150 in the collected data 166, and it also sends the device/user identifier(s) 164 to the media publisher 160. In such other examples, the data collector 152 does not collect the media ID 162 from the media 158 at the client device 146 as the data collector 152 does in the example system 142 of FIG. 1. Instead, the media publisher 160 that publishes the media 158 to the client device 146 retrieves the media ID 162 from the media 158 that it publishes. The media publisher 160 then associates the media ID 162 to the device/user identifier(s) 164 received from the data collector 152 executing in the client device 146, and sends collected data 178 to the app publisher 150 that includes the media ID 162 and the associated device/user identifier(s) 164 of the client device 146. For example, when the media publisher 160 sends the media 158 to the client device 146, it does so by identifying the client device 146 as a destination device for the media 158 using one or more of the device/user identifier(s) 164 received from the client device 146. In this manner, the media publisher 160 can associate the media ID 162 of the media 158 with the device/user identifier(s) 164 of the client device 146 indicating that the media 158 was sent to the particular client device 146 for presentation (e.g., to generate an impression of the media 158).

In some other examples in which the data collector 152 is configured to send the device/user identifier(s) 164 to the media publisher 160, the data collector 152 does not collect the media ID 162 from the media 158 at the client device 146. Instead, the media publisher 160 that publishes the media 158 to the client device 146 also retrieves the media ID 162 from the media 158 that it publishes. The media publisher 160 then associates the media ID 162 with the device/user identifier(s) 164 of the client device 146. The media publisher 160 then sends the media impression data 170, including the media ID 162 and the device/user identifier(s) 164, to the AME 102. For example, when the media publisher 160 sends the media 158 to the client device 146, it does so by identifying the client device 146 as a destination device for the media 158 using one or more of the device/user identifier(s) 164. In this manner, the media publisher 160 can associate the media ID 162 of the media 158 with the device/user identifier(s) 164 of the client device 146 indicating that the media 158 was sent to the particular client device 146 for presentation (e.g., to generate an impression of the media 158). In the illustrated example, after the AME 102 receives the impression data 170 from the media publisher 160, the AME 102 can then send the device/user identifier logs 176a-b to the partner database proprietors 104a-b to request the user information 142a-b as described above.

Although the media publisher 160 is shown separate from the app publisher 150 in FIG. 1, the app publisher 150 may implement at least some of the operations of the media publisher 160 to send the media 158 to the client device 146 for presentation. For example, advertisement providers, media providers, or other information providers may send media (e.g., the media 158) to the app publisher 150 for publishing to the client device 146 via, for example, the app program 156 when it is executing on the client device 146. In such examples, the app publisher 150 implements the operations described above as being performed by the media publisher 160.

Additionally or alternatively, in contrast with the examples described above in which the client device 146 sends identifiers to the audience measurement entity 102 (e.g., via the application publisher 150, the media publisher 160, and/or another entity), in other examples the client device 146 (e.g., the data collector 152 installed on the client device 146) sends the identifiers (e.g., the device/user identifier(s) 164) directly to the respective database proprietors 104a, 104b (e.g., not via the AME 102). In such examples, the example client device 146 sends the media identifier 162 to the audience measurement entity 102 (e.g., directly or through an intermediary such as via the application publisher 150), but does not send the media identifier 162 to the database proprietors 104a-b.

As mentioned above, the example partner database proprietors 104a-b provide the user information 142a-b to the example AME 102 for matching with the media identifier 162 to form media impression information. As also mentioned above, the database proprietors 104a-b are not provided copies of the media identifier 162. Instead, the client provides the database proprietors 104a-b with impression identifiers 180. An impression identifier uniquely identifies an impression event relative to other impression events of the client device 146 so that an occurrence of an impression at the client device 146 can be distinguished from other occurrences of impressions. However, the impression identifier 180 does not itself identify the media associated with that impression event. In such examples, the impression data 170 from the client device 146 to the AME 102 also includes the impression identifier 180 and the corresponding media identifier 162. To match the user information 142a-b with the media identifier 162, the example partner database proprietors 104a-b provide the user information 142a-b to the AME 102 in association with the impression identifier 180 for the impression event that triggered the collection of the user information 142a-b. In this manner, the AME 102 can match the impression identifier 180 received from the client device 146 to a corresponding impression identifier 180 received from the partner database proprietors 104a-b to associate the media identifier 162 received from the client device 146 with demographic information in the user information 142a-b received from the database proprietors 104a-b. The impression identifier 180 can additionally be used for reducing or avoiding duplication of demographic information. For example, the example partner database proprietors 104a-b may provide the user information 142a-b and the impression identifier 180 to the AME 102 on a per-impression basis (e.g., each time a client device 146 sends a request including an encrypted identifier 208a-b and an impression identifier 180 to the partner database proprietor 104a-b) and/or on an aggregated basis (e.g., send a set of user information 142a-b, which may include indications of multiple impressions (e.g., multiple impression identifiers 180), to the AME 102 presented at the client device 146).

The impression identifier 180 provided to the AME 102 enables the AME 102 to distinguish unique impressions and avoid overcounting a number of unique users and/or devices viewing the media. For example, the relationship between the user information 142a from the partner A database proprietor 104a and the user information 142b from the partner B database proprietor 104b for the client device 146 is not readily apparent to the AME 102. By including an impression identifier 180 (or any similar identifier), the example AME 102 can associate user information corresponding to the same user between the user information 142a-b based on matching impression identifiers 180 stored in both of the user information 142a-b. The example AME 102 can use such matching impression identifiers 180 across the user information 142a-b to avoid overcounting mobile devices and/or users (e.g., by only counting unique users instead of counting the same user multiple times).

A same user may be counted multiple times if, for example, an impression causes the client device 146 to send multiple device/user identifiers to multiple different database proprietors 104a-b without an impression identifier (e.g., the impression identifier 180). For example, a first one of the database proprietors 104a sends first user information 142a to the AME 102, which signals that an impression occurred. In addition, a second one of the database proprietors 104b sends second user information 142b to the AME 102, which signals (separately) that an impression occurred. In addition, separately, the client device 146 sends an indication of an impression to the AME 102. Without knowing that the user information 142a-b is from the same impression, the AME 102 has an indication from the client device 146 of a single impression and indications from the database proprietors 104a-b of multiple impressions.

To avoid overcounting impressions, the AME 102 can use the impression identifier 180. For example, after looking up user information 142a-b, the example partner database proprietors 104a-b transmit the impression identifier 180 to the AME 102 with corresponding user information 142a-b. The AME 102 matches the impression identifier 180 obtained directly from the client device 146 to the impression identifier 180 received from the database proprietors 104a-b with the user information 142a-b to thereby associate the user information 142a-b with the media identifier 162 and to generate impression information. This is possible because the AME 102 received the media identifier 162 in association with the impression identifier 180 directly from the client device 146. Therefore, the AME 102 can map user data from two or more database proprietors 104a-b to the same media exposure event, thus avoiding double counting.

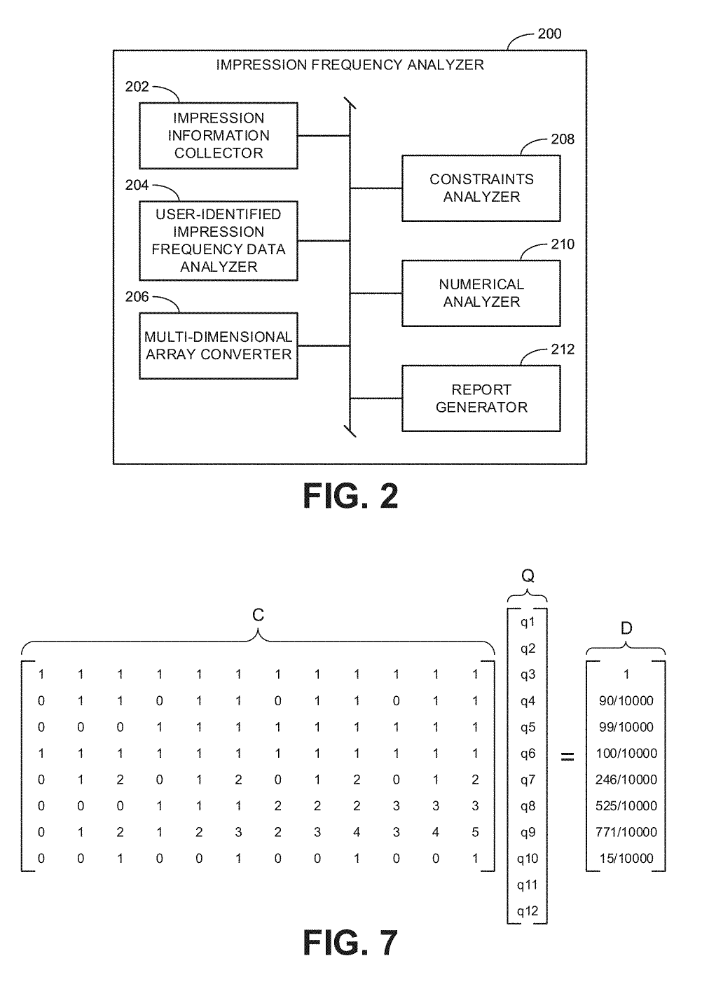

FIG. 2 is a block diagram illustrating an example implementation of the example impression frequency analyzer 200 of FIGS. 1A and 1B to determine frequency distributions for media impressions. The example impression frequency analyzer 200 includes an example impression information collector 202, an example user-identified impression frequency data analyzer 204, an example multi-dimensional array converter 206, an example constraints analyzer 208, an example numerical analyzer 210, and an example report generator 212.

The example impression information collector 202 of FIG. 2 collects impression information from the database proprietor 104. In the illustrated example, the impression information collector 202 collects aggregate-level impression information. Aggregate-level impression information expresses media access measures per demographic group rather than per individual users. In some instances, database proprietors (e.g., the database proprietor 104) share aggregate-level impression data with other parties to prevent exposing specific internet activities, demographics, preferences, and/or other personal identifying information PII) in a manner that such information could be attributable by the other parties to a specific user. Example impression information obtained from the database proprietor 104 includes user-identified impression frequency data, which is data associated with the individuals identifiable by the database proprietor 104 who were exposed to media being monitored and the impression frequency with which such individuals were exposed to the media. The term “user identified” is used herein to correspond to individuals (or data associated with individuals) who are identifiable by the database proprietor 104 because, for example, they are users registered with the database proprietor 104. The user-identified impression frequency data may include the total number of user-identified impressions and/or a user-identified audience size for the media corresponding to the total number of user-identified audience individuals associated with the user-identified impressions. Further, the user-identified impression frequency data may include aggregate numbers of user-identified impressions and/or user-identified audience sizes associated with different media impression frequencies, thereby defining an impression frequency distribution for the media being monitored.

Although examples disclosed herein are described in connection with aggregate-level impression information, the examples are not limited for use with situations in which the impression information is aggregated by database proprietors. Instead, examples disclosed herein may additionally or alternatively be used in instances in which database proprietors provide user-level data to an intermediary party and/or directly to the AME 102. In some examples, the intermediary party and/or the AME 102 generates aggregate level impression information.

The example database proprietor 104 may provide the user-identified impression frequency data (e.g., impression counts, impression counts by impression frequency, audience size, audience size by impression frequency, etc.) for multiple different media items of interest (e.g., different media being monitored by the AME 102). Additionally or alternatively, the example database proprietor 104 may provide the user-identified impression frequency data across different dimensions such as different media device platforms (e.g., mobile, desktop computer, laptop computer, tablet, etc.), different sites or Internet domains through which the media was accessed, different formats and/or placements of the media within the sites, different geographic regions where the media was accessed, etc. In some examples, the user-identified impression frequency data may include impression counts and/or audience sizes for different dimensions by impression frequency as well as combined totals of the different dimensions across the corresponding impression frequencies.

In addition to the user-identified impression frequency data, the impression information may include census data. As used herein, census data refers to information relating to all impressions associated with media being monitored regardless of whether the database proprietor 104 was able to match the impressions to particular individuals. Impressions for which no person could be recognized by the database proprietor 104 are referred to herein as unidentified impressions. In some examples, the census data includes aggregate totals of both user-identified impressions and unidentified impressions, collectively referred to herein as volume or census impressions. While the census data may be obtained from the database proprietor 104, the impression information collector 202 may collect the census data from other sources such as, for example, directly from the client devices 146, via the app publisher 150, and/or the media publisher 160. The census data includes a total number of impressions for the media being monitored whether or not the database proprietor 104 is able to recognize the people associated with the impressions. In some examples, as with the user-identified impression frequency data, the census data may include the number of impressions aggregated into different categories or dimensions (e.g., device platform, Internet site, site placement, geographic region, etc.).

In some examples, the impression information obtained by the impression information collector 202 includes additional information associated with the user-identified individuals recognized by the database proprietor 104. For example, the impression information obtained from the database proprietor 104 may further include aggregate numbers of impressions by demographic group generated by the database proprietor 104 and/or audience sizes from each of the demographic groups.

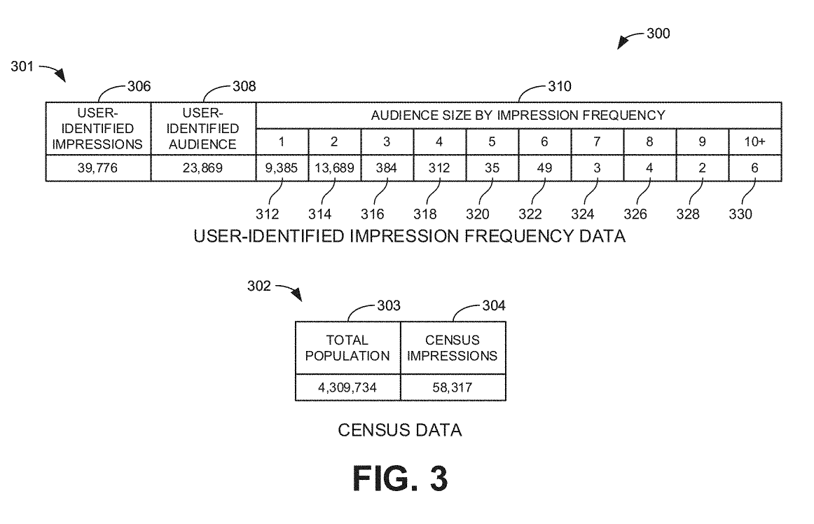

FIG. 3 illustrates example impression information 300 that may be collected by the impression information collector 202 of FIG. 2 from the database proprietor 104 of FIGS. 1A and/or 1B. The example impression information 300 of FIG. 3 corresponds to a one-dimensional summary of a particular media item (e.g., an advertisement, an advertisement campaign, a television program, an episode, or any other media item). The impression information 300 is one-dimensional because the information is generically presented without any breakdown based on different dimensions or parameters. In the illustrated example, the impression information 300 includes user-identified impression frequency data 301 and volume or census data 302. In some examples, the impression information 300 received by the impression frequency analyzer 200 includes additional information not shown in FIG. 3. For example, the impression information 300 may include additional information to identify the particular media represented by the impression information 300 (e.g., the media identifier 162 of FIG. 1B). Additionally, the impression information 300 may further include information to identify the circumstances of the distribution of the media (e.g., the Internet site through which the media was accessed, the placement of the media within this Internet site, the geographic region (e.g., city, designated market area, etc.) where the media was accessed, etc.).

The census data 302 of FIG. 3 corresponds to a population of individuals in the relevant market where the media of interest was distributed, regardless of whether the database proprietor 104 could uniquely identify such individuals. In particular, the census data includes a total population 303, and a total number of census impressions 304. Inasmuch as the census data 302 is not based on specifically identified individuals by the database proprietor 104, in some examples, the impression information collector 202 may receive the census data 302 from a separate source independent of the database proprietor 104.

In the illustrated example, the total population 303 corresponds to the size of a population targeted for the media. For example, if the media is distributed nationwide, the total population 303 would be the population size of the entire country. In the illustrated example of FIG. 3, the impression information 300 corresponds to media distributed in a city or other metropolis region having a population size of approximately 4.3 million. In some examples, the precise population size of a region of interest may not be known. Accordingly, in some examples, the total population 303 is an estimate based on available data. In some examples, the total population 303 is estimated directly by the AME 102 rather than being provided in the impression information 300 received from the database proprietor 104.

The total number of census impressions 304 of FIG. 3 corresponds to the total number of impressions recorded for the particular media item associated with the impression information 300. In some examples, the impression frequency analyzer 200 has access to this number independent of the database proprietor 104 based on the impression data 170 collected from the app publisher 150 and/or the media publisher 160 as described above in connection with FIG. 1B.

Unlike the census data 302 (e.g., the total population 303 and the number of census impressions 304) that may be determined by the impression frequency analyzer 200 independent of the database proprietor 104, the user-identified impression frequency data 301 shown in FIG. 3 is specifically provided by the database proprietor 104 because the user-identified impression frequency data 301 specifically corresponds to user-identified impressions associated with persons (i.e., user-identified individuals) whom the database proprietor 104 recognized or matched to associated user information 142a.

In the illustrated example, the user-identified impression frequency data 301 includes a total number of user-identified impressions 306, a total user-identified audience size 308, and a user-identified impression frequency distribution 310. The number of user-identified impressions 306 corresponds to the portion of the census impressions 304 corresponding to user-identified individuals for whom demographic information is maintained by the database proprietor 104 reporting the impression information 300. That is, the number of user-identified impressions 306 is a count of the number of total impressions for the media that the database proprietor 104 was able to match to a unique individual. The user-identified audience size 308 in FIG. 3 corresponds to the total number user-identified individuals recognized by the database proprietor 104 as corresponding to the user-identified impressions 306. The user-identified audience size 308 is less than the number of user-identified impressions 306 because some of the user-identified individuals counted in the user-identified audience size 308 were exposed to the media more than once (e.g., two or more impressions of the media were logged).

Example numbers of audience members corresponding to different quantities of exposures to the media (i.e., the impression frequencies for the media) are summarily represented by the user-identified impression frequency distribution 310. More particularly, as shown in the illustrated example of FIG. 3, the user-identified impression frequency distribution 310 includes audience sizes for impression frequency groups of specific user-identified individuals indicated by reference numerals 312, 314, 316, 318, 320, 322, 324, 326, 328, 330, and which define the audience sizes of user-identified individuals exposed to the media at different corresponding impression frequencies. The first user-identified audience size 312 in the user-identified impression frequency distribution 310 corresponds to an impression frequency of 1 and, thus, represents the group or number of user-identified individuals in the total user-identified audience size 308 that were exposed to the media only 1 time during a particular monitoring duration. The second user-identified audience size 314 corresponds to an impression frequency of 2, thereby indicating the number of user-identified individuals in the total user-identified audience size 308 that were exposed to the media only 2 times. The numbers of individuals in the total user-identified audience size 308 that are attributed to 3 to 9 impressions are similarly represented in the respective user-identified audience sizes 316, 318, 320, 322, 324, 326, 328 corresponding to the impression frequencies from 3 to 9. The tenth user-identified audience size 330 represents the number of individuals in the total user-identified audience size 308 associated with 10 or more impressions (e.g., 10, 11, 12, etc.). In the illustrated example, all user-identified individuals making up the total the user-identified audience size 308 are accounted for within the user-identified impression frequency distribution 310. That is, the sum of each user-identified audience size associated with each corresponding impression frequency equals the total user-identified audience size 308.

While the user-identified impression frequency distribution 310 provides the numbers of user-identified individuals corresponding to each impression frequency (e.g., each impression frequency specific user-identified audience size 312, 314, 316, 318, 320, 322, 324, 326, 328, 330), the number of user-identified impressions corresponding to each impression frequency may be determined by multiplying each impression frequency specific user-identified audience size 312, 314, 316, 318, 320, 322, 324, 326, 328, 330 by the value of the corresponding impression frequency. For example, the first user-identified audience size 312 includes 9,385 separate user-identified individuals who were each exposed to the media once (hence the impression frequency of 1), resulting in 9,385 (1×9,385) media impressions. The second user-identified audience 314 includes 13,689 separate user-identified individuals, each exposed to the media twice (hence the impression frequency of 2), resulting in 27,378 (2×13,689) media impressions. This same calculation can be used to determine the number of impressions associated with the other impression frequency specific user-identified audience sizes 316, 318, 320, 322, 324, 326, 328 in FIG. 3 except for the tenth impression frequency specific audience size 330.

The exact number of user-identified impressions 306 shown in FIG. 3 corresponding to the tenth user-identified audience size 330 cannot be directly calculated in the above manner because the different user-identified individuals in the group correspond to different impression frequencies. That is, while some of the 6 user-identified individuals identified in the tenth audience size 330 may have been exposed to the media 10 times, others may have been exposed more than 10 times (e.g., 12, 14, 33, etc.) such that multiplying the value of the impression frequency (10) by the size of the audience (6) may underrepresent the actual number of impressions associated with the 6 user-identified individuals. However, the sum of the number of user-identified impressions associated with each specific impression frequency should equal the total number of user-identified impressions 306. Thus, in the illustrated example of FIG. 3, where the total number of user-identified impressions 306 is known, the tenth user-identified audience size 330 in FIG. 3 can still be calculated as the difference between the total of user-identified impressions 306 and the sum of all impressions corresponding with every other impression frequency corresponding to the user-identified audience sizes 316, 318, 320, 322, 324, 326, 328.

As shown in the illustrated example of FIG. 3, the total number of user-identified impressions 306 is less than the number of census impressions 304 by more than 18,000. The portion of the census impressions 304 in excess of the user-identified impressions 306 are referred to herein as unidentified impressions. As described above, the unidentified impressions correspond to individuals the database proprietor 104 was unable to recognize (i.e., unidentified individuals) as being registered users of the database proprietor 104. Inasmuch as the unidentified impressions cannot be tied to uniquely identified individuals, there is no direct way to determine the impression frequency distribution associated with the unidentified impressions. However, examples disclosed herein enable the estimation of a census impression frequency distribution for the census impressions 304 (e.g., including the user-identified impressions and the unidentified impressions) based on the user-identified impression frequency distribution 310.

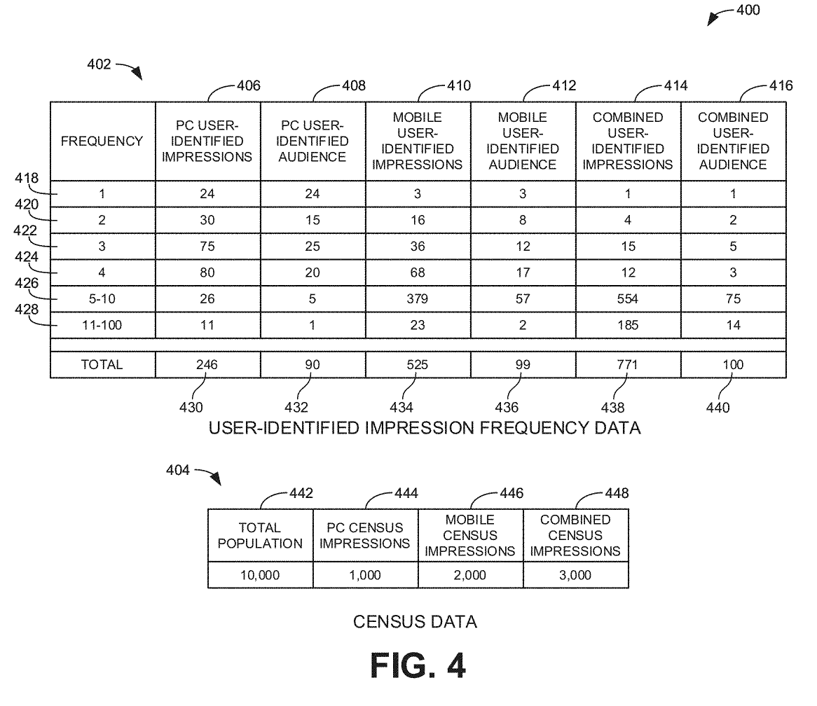

While the example impression information 300 of FIG. 3 is one-dimensional, FIG. 4 illustrates example two-dimensional impression information 400 that may be collected by the impression information collector 202 of FIG. 2 from the database proprietor 104. Different dimensions of impression information may correspond to any factor(s) that can be used to distinguish or separately group different ones of the media impressions. For example, different dimensions may correspond to different platforms (e.g., PC, mobile, tablet, etc.) of the media devices used to deliver the media, different sites (e.g., different websites of the same or different Internet domains) in which the media is provided, different formats for the media (e.g., a banner ad, a popup ad, a floating ad, etc.), different placements of the media (e.g., in the header section of a website, in a sidebar, etc.), different geographic locations (e.g., designated market area), different demographics, and so forth.

In the illustrated example of FIG. 4, the two dimensions (PCs and mobile devices) of the impression information 400 correspond to impressions delivered via personal computer (PC) devices and impressions delivered via mobile devices. As used in the illustrated examples, mobile devices refer to portable handheld computing devices (e.g., smart phones, tablets, etc.), whereas PC devices refer to other computing devices that are not traditionally referred to as mobile devices (e.g., desktop computers, laptop computers, etc.). As in FIG. 3, in the illustrated example of FIG. 4, the impression information 400 includes user-identified impression frequency data 402 that is specifically based on matches between user-identified individuals and media impressions as determined by the database proprietor 104. Additionally, in some examples, the impression information 400 includes census data 404 that does not depend upon the database proprietor 104 recognizing particular individuals. In some examples, the impression information collector 202 may obtain the census data 404 from a source other than the database proprietor 104.

The example user-identified impression frequency data 402 in FIG. 4 is represented in a table that includes six columns corresponding to a number of PC user-identified impressions 406, a PC user-identified audience size 408, a number of mobile user-identified impressions 410, a mobile user-identified audience size 412, a number of combined user-identified impressions 414, and a combined user-identified audience size 416. Each of the columns represents a distribution of the user-identified impressions or user-identified audience sizes corresponding to different impression frequencies identified for each row 418, 420, 422, 424, 426, 428 of the table in FIG. 4. As shown in the illustrated example, the first four rows 418, 420, 422, 424 correspond to individual impression frequencies from 1 to 4, respectively. The fifth row 426 corresponds to an aggregate of impression frequencies ranging from 5 to 10 and the sixth row 428 corresponds to an aggregate of impression frequencies ranging from 11 to 100.

In the illustrated example of FIG. 4, the combined user-identified impressions 414 (and the associated combined user-identified audience sizes 416) correspond to media accessed either via a PC device or via a mobile device. That is, although the impression information 400 is two-dimensional (between PC devices and mobile devices), there is additional information under the combined data columns that represents the interaction or relationship between PC impressions and mobile impressions. Because the combined impressions correspond to a combination of both PC impressions and mobile impressions, many individuals associated with lower impression frequencies in either the PC or mobile data are placed in a higher frequency bracket for the combined data. For example, one individual may have experienced two impressions via a PC device (for an impression frequency of 2) and one impression via a mobile device (for an impression frequency of 1) resulting in a total of three impressions (e.g., an impression frequency of 3) for the combined data.

In the illustrated example of FIG. 4, a total number (across all impression frequencies) of PC user-identified impressions 430 is determined by summing the PC user-identified impressions 406 at each of the impression frequencies represented in the user-identified impression frequency data 402. In the illustrated example, the total PC user-identified impressions 430 corresponds to 246 impressions. The total PC user-identified audience size 432 corresponding to the 246 PC user-identified impressions corresponds to 90 user-identified individuals. In a similar manner, the total number of mobile user-identified impressions 434 is 525, which corresponds to a total mobile user-identified audience size 436 of 99. Further, the total number of combined user-identified impressions 438 (i.e., all user-identified impressions) is 771, which corresponds to a total combined user-identified audience size 440 (i.e., the total number of user-identified individuals) of 100. As shown in the illustrated example, the total number of combined user-identified impressions 438 corresponds to the sum of the total number of PC user-identified impressions 430 and the total number of mobile user-identified impressions 434. By contrast, the total combined user-identified audience size 440 corresponds to much less than the sum of the total PC user-identified audience size 432 and the total mobile user-identified audience size 436. This difference is accounted for by the overlap of user-identified individuals in each of the PC user-identified audience 408 and the mobile user-identified audience 412. As described more fully below, the combined data (e.g., the combined user-identified impressions 414 and the combined user-identified audience size 416) enables an analysis of the interrelationship of the different dimensions (e.g., PC versus mobile) of the impression information 400.

In the illustrated example of FIG. 4, the census data 404 includes a total population 442, a total number of PC census impressions 444, a total number of mobile census impressions 446, and a total number of combined census impressions 448. The total population 442 corresponds to the total number of individuals estimated for the target market for the media being monitored. In some examples, this is determined based on the population within the geographic region of the media distribution (e.g., the population of a particular city). In the illustrated example of FIG. 4, the example total population 442 for the target market is estimated to be 10,000.

The total number of PC census impressions 444 is indicative of the total number of impressions occurring via PC devices as tracked by the AME 102. The total number of PC census impressions 444 includes the total number of PC user-identified impressions 430 plus all unidentified impressions associated with individuals the database proprietor 104 was unable to recognize. Similarly, the total number of mobile census impressions 446 is indicative of the total number of impressions occurring via mobile devices as tracked by the AME 102. In the illustrated example, the total number of PC census impressions 444 corresponds to 1000 impressions and the total number of mobile census impressions 446 corresponds to 2000 impressions. The total number of combined census impressions 448 corresponds to the total number of impressions tracked across all dimensions (i.e., via both PC devices and mobile device). Thus, the total number of combined census impressions 448 corresponds 3000 impressions (i.e., the sum of the total number of PC census impressions 444 and the total number of mobile census impressions 446).

Returning to FIG. 2, the example impression frequency analyzer 200 is provided with the user-identified impression frequency data analyzer 204 to analyze the user-identified impression frequency data (e.g., the user-identified impression frequency data 301) obtained from the database proprietor 104. In some examples, the user-identified impression frequency data analyzer 204 determines probabilities for different impression frequencies based on the impression frequency distribution information in the user-identified impression frequency data. When the user-identified impression frequency data provides the audience size corresponding to a particular impression frequency of k, the probability (qₖ) that a person in a target market defined by the user-identified impression frequency data will be exposed to media k times (i.e., an impressions impression frequency of k) is calculated as the proportion of the audience size relative to the total population in the target market (e.g., the total population 442 of FIG. 4). For example, the PC user-identified audience size 408 for an impression frequency of 2, as shown in FIG. 4, corresponds to 15 user-identified individuals. Thus, with the total population 442 assumed to be 10,000, the probability of an impression frequency of 2 via a PC device is 15/10,000=0.15%.

A complete user-identified probability distribution Q for user-identified impression frequencies includes the probability that a person in the target market is not exposed to the media of interest (i.e., q₀ corresponding to an impression frequency of 0). This corresponds to the non-reach portion of the total population or the total population less the total user-identified audience size. Expressed as a percentage, the probability (q₀) of an impression frequency of 0 corresponds to the difference between the total population and the total user-identified audience size divided by the total population. To use the example of FIG. 4, the difference between the total population 442 (10,000) and the total PC user-identified audience size 432 (90) is 9,910 resulting in a probability of non-reach being 9,910/10,000=99.1%.

Where the user-identified audience size for each impression frequency of interest is provided, the user-identified impression frequency data analyzer 204 of the illustrated example is able to directly determine a complete user-identified probability distribution Q by dividing each impression frequency specific audience size by the total population and calculating the non-reach portion as described above. However, in some examples, the audience size for a particular impression frequency of interest may not be available. For example, there is no way to directly calculate the probability associated with an impression frequency of 10 based on the user-identified impression frequency data 301 of FIG. 3 because the audience size reported for that impression frequency corresponds to an impression frequency of 10 or higher. As such, there is no way of directly determining what portion of the user-identified audience size 330 (6 individuals in FIG. 3) corresponds to an impression frequency of 10 as opposed to some other impression frequency higher than 10. Further, the user-identified impression frequency data analyzer 204 may not be able to directly calculate the probabilities for the interaction of impressions in different dimensions of multi-dimensional data. For example, while the user-identified impression frequency data 402 of FIG. 4 can be used to determine the probability of an impression frequency of 2 for just PC devices, just mobile devices, or both PC and mobile devices when considered in combination, there is no direct way of determining the interrelationships between impressions via PC devices and impressions via mobile devices at the impression frequency of interest. That is, while the probability that a person is exposed to media twice through at least one of a PC device or a mobile device can be determined from the combined data provided in FIG. 4, there is no indication of the probability of the two impressions both being delivered via a PC device (and none via a mobile device), relative to the probability of both impressions being delivered via a mobile device (and none via a PC device), and relative to one impression being delivered via each of a PC device and a mobile device. More generally, as used herein, an interaction of impressions between two dimensions refers to the likelihood of an individual (or the number of individuals within a total population) being exposed to media X number of times (i.e., an impression frequency of X) in the first dimension and being exposed to the media Y number of times (i.e., an impression frequency of Y) in the second dimension.

Examples disclosed herein estimate the probabilities for a complete user-identified probability distribution Q that cannot be directly determined using the principle of maximum entropy. In mathematical terms, an impression frequency distribution is infinite as any impression frequency is theoretically possible (for an infinite number of impressions). Accordingly, in some examples, the user-identified impression frequency data analyzer 204 determines a suitable stopping point or largest impression frequency to be considered, beyond which the probability is considered negligible and, therefore, set to zero. In some examples, the largest impression frequency is determined based on the user-identified impression frequency data. For example, in FIG. 3, there are only 6 unique audience individuals corresponding to an impression frequency of 10 or higher. Multiplying each impression frequency specific audience size by its corresponding impression frequency and summing the values reveals that a total of 73 impressions are associated with the 6 user-identified individuals associated with an impression frequency of 10 or more (using 6×10=60 in the summation results in 13 less people than the total user-identified audience size 308 indicating the 6 user-identified individuals account for 60+13=73 impressions). If it is assumed that 5 of the 6 individuals were exposed to the media 10 times (the lowest possible impression frequency) for a total of 50 impressions, the sixth person would have to account for the remaining 23 impressions. Therefore, the maximum possible impression frequency for any individual based on the user-identified impression frequency data 301 of FIG. 3 is 23. Accordingly, in some examples, the user-identified impression frequency data analyzer 204 may determine a largest impression frequency to analyze that is at least as high as 23. While it is probable that the 73 impressions are divided more evenly among the 6 unique audience individuals, the example user-identified impression frequency data analyzer 204 may select a largest impression frequency to be analyzed or estimated that is even greater than 23 (e.g., 50, 100, etc.) to account for potential outliers beyond what is represented by the user-identified impression frequency data 301.

The largest impression frequency to be estimated as determined by the example user-identified impression frequency data analyzer 204 defines the total number of separate probabilities in the probability distribution Q for impression frequencies. That is, if the largest impression frequency is set to 100, there would be 101 probabilities to be calculated for a one-dimensional case including the probability (q₀) for an impression frequency of 0 and the probabilities for impression frequencies ranging from 1 (q₁) to 100 (q₁₀₀). Where the user-identified probability distribution Q is to represent two dimensions, the total number of probabilities corresponds to the square of one plus the largest impression frequency. For example, if the largest impression frequency is defined to be 100, the total number of probabilities in a two-dimensional probability distribution Q is 101×101=10,201.

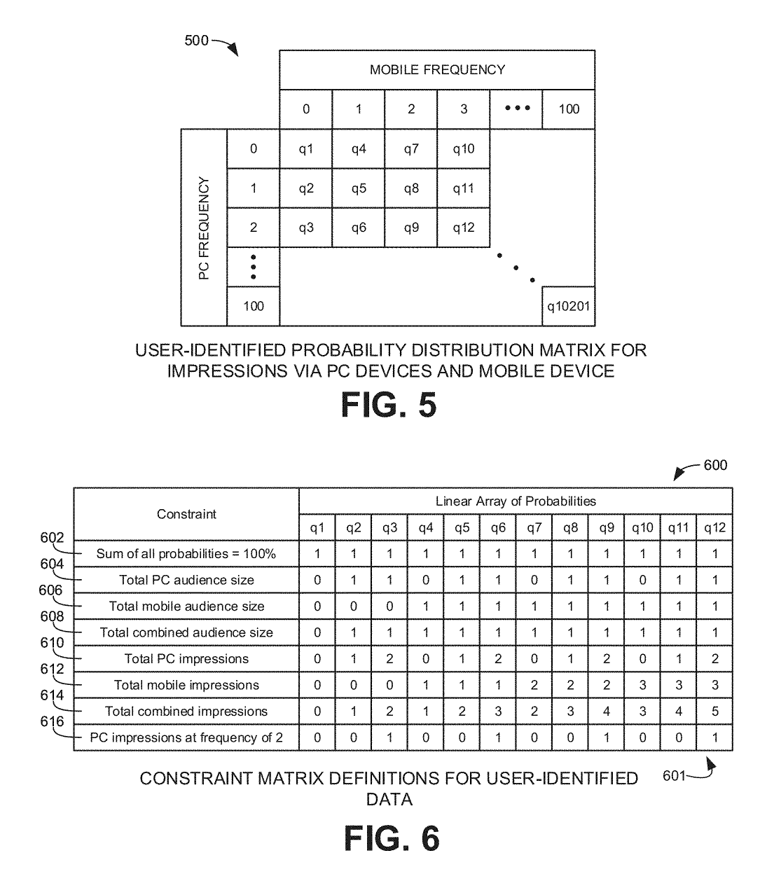

The more than 10,000 probabilities to represent the interrelationship of impression frequencies between two dimensions is represented by the table or two-dimensional array or matrix 500 of FIG. 5. As shown in the illustrated example of FIG. 5, for user-identified individuals associated with each impression frequency i occurring via a PC device from 0 (no impressions) to 100, the same individuals may be associated with impressions occurring via a mobile device at any impression frequency j from 0 (no impressions) to 100, resulting in the table 500 of over 10,000 different relationships or interactions between PC and mobile devices each with its own probability (qᵢⱼ).

To facilitate analysis of the probabilities in the table 500, the example impression frequency analyzer 200 is provided with the example multi-dimensional array converter 206 (FIG. 2) to convert the two-dimensional user-identified probability distribution Q represented by the table 500 of probabilities (qᵢⱼ) into a one-dimensional array by labeling each probability in succession. For example, as shown in the illustrated example of FIG. 5, the probabilities are labeled from q1 corresponding to an impression frequency of 0 for each of the PC and mobile dimensions (e.g., q₀₀ in the two-dimensional distribution) up to q14201 corresponding to the interaction in the PC and mobile dimensions at an impression frequency of 100 in each dimension. For purposes of explanation, only a portion of the user-identified probability distribution Q represented in the table 500 corresponding to impression frequencies from 0 to 3 in the mobile dimension and from 0 to 2 in the PC dimension will be described. The ordering of the labelling of the probabilities is not important but may be defined in any suitable manner. For example, in FIG. 5, each probability in the first column of the illustrated portion of the table 500 (corresponding to a mobile impression frequency of 0) is labelled in succession before continuing the labelling in the next column of the illustrated portion (corresponding to the mobile impression frequency of 1). This labeling enables the probabilities of the two-dimensional probability distribution Q of the table 500 to be represented as a one-dimensional array of probabilities.

While the values for each of the probabilities of Q may not be known, the user-identified impression frequency data 402 of FIG. 4 can be analyzed by the example constraints analyzer 208 of FIG. 2 to define constraints that the user-identified probability distribution Q must satisfy to properly model the user-identified impression frequency data 402. In particular, the example constraints analyzer 208 may define constraints to set up a linear system expressed as CQ=D, where C is a constraint matrix, Q is the probability distribution noted above represented as a one-dimensional array arranged in a column matrix, and D is a column matrix containing known values from the user-identified impression frequency data 402 corresponding to the defined constraint matrix C. More particularly, the constraint matrix C contains entries in each row that may be multiplied by the corresponding entry (i.e., probability) in Q and summed to produce the associated constraint value in D.

FIG. 6 illustrates an example table 600 to define a constraint matrix 601 for the one-dimensional array of probabilities q1-q12 identified in the two-dimensional table 500 of FIG. 5. Each row 602, 604, 606, 608, 610, 612, 614, 616 in FIG. 6 corresponds to a different constraint identified by the example constraint analyzer 208. In the illustrated example of FIG. 6, the first row 602 corresponds to the constraint that the sum of all probabilities in Q must equal 1 (i.e., 100%). As shown in FIG. 6, each entry in the first row 602 of the constraint matrix 601 is set to 1. As such, when the constraint matrix 601 is multiplied by the column matrix of the one-dimensional array of the user-identified probability distribution Q, all probabilities (q1-q12) will be added. This constraint can be expressed mathematically for any two-dimensional data set as follows:

Σᵢ₌₀ⁿΣⱼ₌₀ⁿqᵢⱼ=1 (Equation 1)

where n is the highest impression frequency being analyzed and qᵢⱼ is the probability of the intersection of an impression frequency of i in the first dimension (e.g., PC) and an impression frequency of j in the second dimension (e.g., mobile). The two-dimensional notation of i and j can be matched to the one-dimensional array labels for Q by reference to FIG. 5. For example, a PC impression frequency of 1 (i=1) and a mobile impression frequency of 2 (j=2) corresponds to the probability labelled q8 in FIG. 5

In the illustrated example of FIG. 6, the second row 604 corresponds to the constraint defined by the total PC user-identified audience size 432 of FIG. 4. More particularly, the constraint may be stated as the proportion of user-identified individuals from the total population that accessed the media of interest at least once via a PC device, as modeled by the user-identified probability distribution Q, must equal the total PC user-identified audience size 432 provided in the user-identified impression frequency data 402 of FIG. 4. To establish this constraint, each entry in the second row 604 of the constraint matrix 601 is set to 1 except for those entries corresponding to q1, q4, q7, and q10 because, as shown in FIG. 5, these probabilities correspond to an impression frequency of 0 via a PC device. This constraint can be expressed mathematically for any two-dimensional data set as follows:

$${\sum }_{i = 1}^{n} {\sum }_{j = 0}^{n} {q}_{ij} = \frac{{UI}_{1}}{TP} \qquad ( Equation 2 )$$

where UI₁ is the total user-identified audience size for the first dimension and TP is the total population of the target market. Using the example user-identified impression frequency data 402 of FIG. 4, the constraint value corresponds to the PC user-identified audience size 432 (90 audience members) divided by the total population 442 (10,000 population size), which equals 90/10,000=0.9%.

In the illustrated example of FIG. 6, the third row 606 corresponds to the constraint defined by the total mobile user-identified audience size 436 of FIG. 4. More particularly, the constraint may be stated as the proportion of user-identified individuals from the total population that accessed the media of interest at least once via a mobile device, as modeled by the user-identified probability distribution Q, must equal the total mobile user-identified audience size 436 provided in the user-identified impression frequency data 402 of FIG. 4. This constraint is comparable to the constraint in the third row 604 except that it is associated with mobile devices rather than PC devices. Thus, each entry in the third row 606 of the constraint matrix 601 is set to 1 except for those entries corresponding to an impression frequency of 0 via a mobile device (e.g., q1, q2, and q3 in the example table 500 of FIG. 5). This constraint can be expressed mathematically for any two-dimensional data set as follows:

$${\sum }_{i = 0}^{n} {\sum }_{j = 1}^{n} {q}_{ij} = \frac{{UI}_{2}}{TP} \qquad ( Equation 3 )$$

where UI₂ is the total user-identified audience size for the second dimension and TP is the total population of the target market. Using the example user-identified impression frequency data 402 of FIG. 4, the constraint value corresponds to the mobile user-identified audience size 436 (99 audience members) divided by the total population 442 (10,000 population size), which equals 99/10,000=0.99%.

In the illustrated example of FIG. 6, the fourth row 608 corresponds to the constraint defined by the total combined user-identified audience size 440 of FIG. 4. More particularly, the constraint may be stated as the proportion of user-identified individuals from the total population that accessed the media of interest at least once via either a mobile device or a PC device, as modeled by the user-identified probability distribution Q, must equal the total combined user-identified audience size 440 provided in the user-identified impression frequency data 402 of FIG. 4. This constraint is comparable to the constraints in the second and third rows 604, 606 except that it is associated with the combined data corresponding to both PC and mobile devices. Thus, each entry in the fourth row 608 of the constraint matrix 601 is set to 1 except for the first entry corresponding to q1 when both the PC impression frequency and the mobile impression frequency is 0. This constraint can be expressed mathematically for any two-dimensional data set as follows:

$${\sum }_{i = 1}^{n} {\sum }_{j = 1}^{n} {q}_{ij} + {\sum }_{j = 1}^{n} {q}_{0 j} + {\sum }_{i = 1}^{n} {q}_{i 0} = \frac{{UI}_{c}}{TP} \qquad ( Equation 4 )$$

where UI_{c} is the total combined user-identified audience size (for both dimensions) and TP is the total population of the target market. Using the example user-identified impression frequency data 402 of FIG. 4, the constraint value corresponds to the combined user-identified audience size 440 (100 audience members) divided by the total population 442 (10,000 population size), which equals 100/10,000=1%. This constraint may additionally or alternatively be expressed with respect to the non-reach population represented by the probability q1 in the table 500 of FIG. 5. That is, rather than setting all entries to 1 in the fourth row except for the entry associated with q1, the entry in the constraint matrix 601 corresponding to q1 may be set to 1 with all other entries set to zero. In such examples, the corresponding constraint value is the difference between the total population 442 (10,000 population size) and the total combined user-identified audience size 440 (100 audience members) divided by the total population 442 (10,000 population size). This constraint may be expressed mathematically for any two-dimensional data set as follows:

$${q}_{00} = \frac{TP - {UI}_{c}}{TP} \qquad ( Equation 5 )$$

where q₀₀ is the probability corresponding to an impression frequency of 0 for both dimensions, UI_{c} is the total combined user-identified audience size (for both dimensions), and TP is the total population of the target market.

While each of the constraints associated with the second, third, and fourth rows 604, 606, 608 of the constraint matrix 601 corresponds to the corresponding user-identified audience size 432, 436, 440, the constraint values are defined as ratios of the audience sizes to the total population 442 to be expressed as percentages. In some examples, the entries in the user-identified probability distribution Q (q1, q2, q3, etc.) are probabilities or percentages defined relative to the total population. For this reason, the constraints defined by Equations 2-5 above are expressed as the user-identified audience size divided by the total population. In some examples, the total population could be moved to the other side of the Equations 2-5 to perform the calculations based on the actual number of user-identified individuals corresponding to the user-identified audience sizes. In such examples, the other constraints would also need to be adjusted by the total population. That is, Equation 1 corresponding to the first constraint would be modified to equal the sum of all individuals (i.e., the total population) rather than the sum of all probabilities (i.e., 100%).

In contrast to the second, third, and fourth rows 604, 606, 608 of FIG. 6 that are based on the user-identified audience size relative to the total population, the fifth, sixth, and seventh rows 610, 612, 614 of the constraint matrix 601 are based on the number of impressions relative to the total population. For example, the fifth row 610 corresponds to the constraint that the number of user-identified impressions occurring via a PC device, as modeled by the user-identified probability distribution Q, must equal the total number of user-identified impressions 430 provided in the user-identified impression frequency data 402 of FIG. 4. As shown in the illustrated example, each entry in the fifth row 610 of the constraint matrix 601 is set to the value of the PC impression frequency for that particular entry. For example, entries in the fifth row 610 corresponding to probabilities q1, q4, q7, and q10 are set to 0 because they correspond to a PC impression frequency of 0, entries corresponding to probabilities q2, q5, q8, q11 are set to 1 because they correspond to a PC impression frequency of 1, and entries corresponding to probabilities q3, q6, q9, q12 are set to 2 because they correspond to a PC impression frequency of 2. A similar approach is followed to specify the values of the entries for the sixth row 612 corresponding to mobile impressions. The entries in the constraint matrix 601 for the seventh row 614 corresponding to the combined impressions are based on the sum of the PC impression frequency and the mobile impression frequency associated with the particular probability. For example, as shown in FIG. 5, q9 is associated with a PC impression frequency of 2 and a mobile impression frequency of 2 resulting in a corresponding value in the seventh row 614 at the entry associated with q9 of 2+2=4.

The value of each entry in the fifth, sixth, and seventh rows 610, 612, 614 of the constraint matrix 601 is set to the corresponding value(s) of the impression frequency in the dimension(s) of interest so that the when the value is multiplied by the corresponding probability (q1, q2, q3, etc.) the result will be proportional to the number of impressions at that frequency. The result is proportional to the number of impressions because it corresponds to the number of impressions divided by the total population. These constraints can be expressed mathematically for any two-dimensional data set as follows:

$$\begin{matrix}{\sum }_{i = 0}^{n} {\sum }_{j = 0}^{n} {iq}_{ij} = \frac{{TI}_{1}}{TP} & ( Equation 6 ) \\ {\sum }_{i = 0}^{n} {\sum }_{j = 0}^{n} {jq}_{ij} = \frac{{TI}_{2}}{TP} & ( Equation 7 ) \\ {\sum }_{i = 0}^{n} {\sum }_{j = 0}^{n} ( i + j ) {q}_{ij} = \frac{{TI}_{c}}{TP} & ( Equation 8 )\end{matrix}$$

where Equation 6 is the constraint based on impressions corresponding to the first dimension (e.g., PC) in which TI₁ is the total user-identified impressions for the first dimension; Equation 7 is the constraint based on impressions corresponding to the second dimension (e.g., mobile) in which TI₂ is the total user-identified impressions for the second dimension; and Equation 8 is the constraint based on impressions corresponding to the combination of dimensions in which TI_{c} is the total combined user-identified impressions.

The constraints associated with each of the second through seventh rows 604, 606, 608, 610, 612, 614 of the constraint matrix 601 are based on the aggregated totals of impressions across all impression frequencies (e.g., the total user-identified impressions 430, 434, 438 of FIG. 4) or the aggregated total audience sizes across all impression frequencies (e.g., the total user-identified audience sizes 432, 436, 440 of FIG. 4). In some examples, the constraints analyzer 208 of FIG. 2 may determine additional constraints based on known information about specific impression frequencies from the user-identified impression frequency data 402. For example, apart from the totals 430, 432, 344, 436, 438, 440 in FIG. 4, the user-identified impression frequency data 402 of FIG. 4 provides 36 separate values corresponding to different impression counts or audience sizes at different impression frequencies. In some examples, the constraints analyzer 208 may define a separate constraint in the constraint matrix 601 for some or all of these 36 values.

For example, the eighth row 616 of the constraint matrix 601 corresponds to the constraint associated with the PC user-identified audience size 408 in the second row 420 (i.e., at an impression frequency of 2) of the user-identified impression frequency data 401 of FIG. 4. As shown in FIG. 5, the PC impressions at an impression frequency of 2 correspond to the probabilities of q3, q6, q9, q12 such that the corresponding entries in the constraint matrix 601 are set to 1 with all other entries set to 0. Similar constraints may be defined for each of the 36 values in the user-identified impression frequency data 402 mentioned above.

FIG. 7 illustrates the values for the linear system CQ=D, where C is the constraint matrix 601 of FIG. 6, Q is the user-identified probability distribution represented as a one-dimensional array arranged in a column matrix, and D is the column matrix containing the values of the constraints corresponding to the constraint matrix 601. The example linear system of FIG. 7 is limited to the portion of the user-identified probability distribution Q labelled in the table 500 of FIG. 5 from q1 to q12. The full linear system would include probabilities up to q14201 (when the largest impression frequency is set to 100) with the constraint matrix 601 having a corresponding number of columns. Further, as described above, the constraint matrix 601 may have additional rows corresponding to additional constraint values in the column matrix D. In the illustrated example of FIG. 7, the constraint values are represented as ratios with respect to the total population 442 (i.e. 10,000) for easier reference to the corresponding values in the user-identified impression frequency data 402 of FIG. 4.

As described above, the example constraint analyzer 208 defines the constraint matrix 601 based on the ordered labeling of the one-dimensional array of probabilities. That is, if the ordering of the labelling were changed, the resulting constraint matrix 601 would also change. Furthermore, the particular constraints accounted for in the constraint matrix 601 are based on the available information known from the user-identified impression frequency data 402. Accordingly, changes in the groupings or distribution of the impression frequencies may affect the number of rows in the constraint matrix 601 and/or the values of the entries in such rows. In examples where the database proprietor 104 does not provide any combined data (e.g., combined user-identified impressions and/or combined audience sizes), the two-dimensional impression frequency distribution data may be reduced to two separate one-dimensional problems as there is no information to calculate the interaction between the two dimensions. The procedures to develop a constraint matrix for one-dimensional data (e.g., the user-identified impression frequency data 301) is similar to that described above in connection with FIGS. 4-7 except that there is likely to be fewer constraints.

Returning to FIG. 2, the example impression frequency analyzer 200 is provided with the example numerical analyzer 210 to solve for the probabilities in the user-identified probability distribution Q that satisfy the constraints. There may be an infinite number of solutions. Accordingly, in some examples, the numerical analyzer 210 calculates the solution for Q that satisfies the principle of maximum entropy consistent with the constraints. The problem can be expressed mathematically as solving for Q such that the function, F(Q), in Equation 9 below is maximum consistent with the constraints:

F(Q)=−Σₖ₌₁^{m}qₖ log(qₖ) (Equation 9)

where qₖ is the kth probability of the user-identified probability distribution Q when represented as a one-dimensional array of probabilities, and m is the highest probability label in the one-dimensional array. The solution to Equation 9 above may be solved numerically using any suitable numerical method.

Once the numerical analyzer 210 has solved for the user-identified probability distribution Q, the solution can be used to estimate a probability distribution P for the census data (e.g., the census data 404). That is, while the user-identified probability distribution Q models the impressions associated with individuals that the database proprietor 104 could recognize, the census probability distribution P models all impressions for a media item whether the impressions correspond to user-identified individuals (recognized by the database proprietor 104) or unidentified individuals. In some examples, the census probability distribution P is determined by satisfying the principle of minimum cross entropy between P and Q in a manner consistent with constraints defined by the census data.

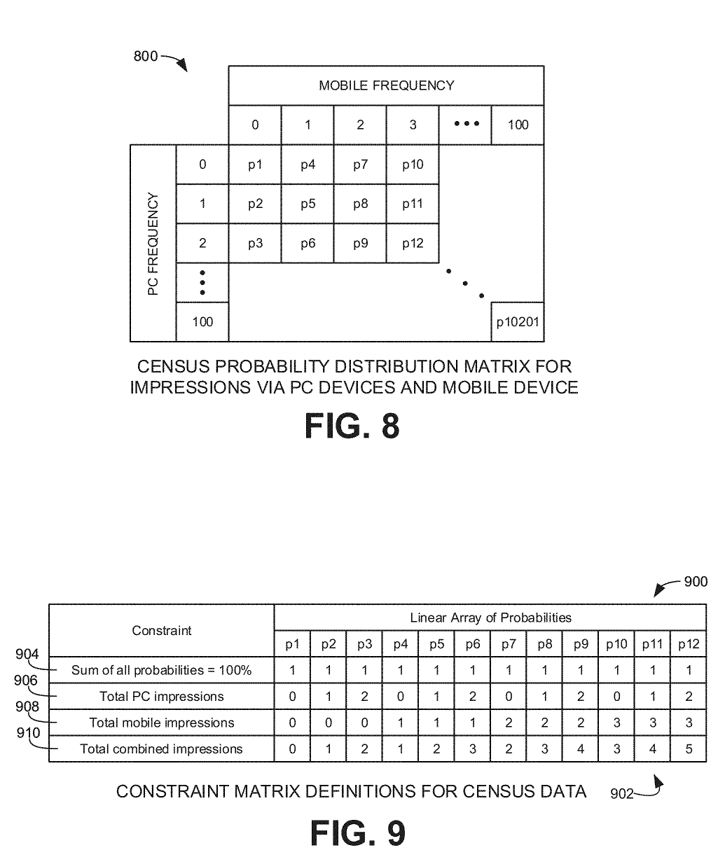

For the minimum cross entropy analysis to be valid, the probabilities in P (e.g., p1, p2, p3, etc.) must correspond to the probabilities in Q (e.g., q1, q2, q3, etc.). Accordingly, in some examples, the multi-dimensional array converter 206 (FIG. 2) converts a two-dimensional array or table 800 of probabilities for the census data, shown in FIG. 8, into a one-dimensional array by labeling each probability in succession in the same order as was done with respect to the user-identified probability distribution Q shown in the table 500 in FIG. 5. With the census probability distribution P defined as a one-dimensional array corresponding to the ordering of the probabilities in the user-identified probability distribution Q, a linear system of constraints can be defined as CP=D, where C is a constraint matrix, P is the census probability distribution with probabilities represented as a column matrix, and D is a column matrix containing known values from the census data corresponding to the defined constraint matrix C. FIG. 9 illustrates an example table 900 to define a constraint matrix 902 for the one-dimensional array of probabilities p1-p12 identified in the two-dimensional table 800 of FIG. 8.

The values for the entries in the constraint matrix 902 are determined by the constraints analyzer 208 in a similar manner as the constraint matrix 601 of FIG. 6. For example, the first row 904 corresponds to the constraint that the sum of all probabilities in P must equal 1 (e.g., 100%) similar to the first row 602 in FIG. 6. The second row 906 of FIG. 9 is comparable to the fifth row 610 of FIG. 6 corresponding to PC impressions except that FIG. 9 is based on the census data 404 rather than the user-identified impression frequency data 402. That is, the second row 906 of FIG. 9 corresponds to the constraint that the total number of impressions occurring via a PC device, as modelled by the census probability distribution P, must be proportional to the total number of PC census impressions 444 (e.g., 1000 impressions) provided in the census data 404 of FIG. 4. As explained above, the constraint is the ratio of the PC census impressions 444 (1,000 impressions) to the total population 442 (10,000 population size) resulting in a constraint value of 1000/10,000=0.1. Similarly, the third row 908 of FIG. 9 is comparable to the sixth row 612 of FIG. 6 corresponding to mobile impressions except that FIG. 9 is based on the census data 404 rather than the user-identified impression frequency data 402. Thus, the constraint value corresponding to the third row is the ratio of the mobile census impressions 446 (2,000 impressions) to the total population 442 (10,000 population size), resulting in a value of 2000/10,000=0.2. Likewise, the fourth row 910 of FIG. 9 is comparable to the seventh row 614 of FIG. 6 corresponding to combined impressions except that FIG. 9 is based on the census data 404 rather than the user-identified impression frequency data 402. Thus, the constraint corresponding to the third row is the ratio of the combined census impressions 448 (3,000 impressions) to the total population 442 (10,000 population size), resulting in a value of 3000/10,000=0.3.

Unlike the table 600 in FIG. 6, none of the constraints in the table 900 of FIG. 9 relate to counts of individuals corresponding to particular impression frequencies or to an aggregated total audience size across all impression frequencies. In the illustrated example, the constraint matrix 902 is limited to total impressions because that is the only information that is available from the census data 404. Estimating the total audience size corresponding to the impressions reported in the census data 404 and/or estimating the audience sizes corresponding to particular impression frequencies (i.e., the impression frequency distribution) for the census data is one of the objectives accomplished by the examples disclosed herein.

In some examples, the example numerical analyzer 210 may solve for the probabilities in the census probability distribution P that satisfy the constraints defined by the constraints analyzer 208 based on the census data. There are an infinite number of solutions. Accordingly, in some examples, as mentioned above, the numerical analyzer 210 calculates the solution for P that satisfies the principle of minimum cross entropy between P and Q in a manner consistent with constraints defined by the census data. This can be expressed mathematically as solving for P such that the function, F(P:Q), in Equation 10 below is minimum consistent with defined constraints:

$$F ( P \text{:} Q ) = {\sum }_{k = 1}^{m} {p}_{k} log ( \frac{{p}_{k}}{{q}_{k}} ) \qquad ( Equation 10 )$$

where pₖ is the kth probability of the census probability distribution P when represented as a one-dimensional array of probabilities, qₖ is the kth probability of the user-identified probability distribution Q represented as a one-dimensional array of corresponding probabilities, and m is the highest probability label in the one-dimensional arrays. The solution to Equation 10 above may be solved numerically using any suitable numerical method.

Once the numerical analyzer 210 (FIG. 2) converges on a solution for the census probability distribution P, the one-dimensional array of probabilities (p1, p2, p3, etc.) may be applied to the entries in the two-dimensional array or table 900 of FIG. 9. The example report generator 212 (FIG. 2) may use the table 900 populated with the calculated values to generate reports or estimates of any combination of probabilities for the census data 404. For example, the sum of any particular row in the table 900 corresponds to the census audience size at the PC impression frequency corresponding to the particular row. More particularly, the summation corresponds to the audience size as a proportion of the total population but the actual number of individuals in the census audience at the relevant impression frequency may be calculated by multiplying the result by the total population. Similar to a particular PC impression frequency, the sum of any particular column in the table 900 corresponds to the census audience size at the mobile impression frequency corresponding to the particular column. The report generator 212 may estimate the audience size for multiple different PC impression frequencies or mobile impression frequencies by adding the values from each relevant row (PC impression frequencies) or column (mobile impression frequencies).

The audience size for a particular impression frequency based on the combined data (e.g., via both PC and mobile devices in the illustrated examples) corresponds to the diagonal in the table 900 associated with entries where the sum of the PC impression frequency and mobile impression frequency is equivalent to the particular impression frequency of interest. For example, the audience size for a combined impression frequency of 2 corresponds to the sum of the audience sizes indicated along the diagonal defined by (1) the mobile impression frequency of 0 and the PC impression frequency of 2 (e.g., p3 in FIG. 9), (2) the mobile impression frequency of 1 and the PC impression frequency of 1 (e.g., p5 in FIG. 9), and (3) the mobile impression frequency of 2 and the PC impression frequency of 0 (e.g., p7 in FIG. 9).

Further, the report generator 212 may determine the audience size corresponding to the total number of individuals associated with the total number of census impressions for the media (e.g., the combined census impressions 448 of FIG. 4) based on the sum of all probabilities in the table 900 except for the value corresponding to a PC impression frequency of 0 and a mobile impression frequency of 0 (e.g., p1 in FIG. 9).

Beyond audience sizes at particular impression frequencies of interest, the report generator 212 may generate reports indicating the number of impressions at the particular impression frequencies of interest. More particularly, the total count of census impressions at a particular impression frequency is calculated by multiplying the audience size at the impression frequency of interest by the value of impression frequency of interest.

While an example manner of implementing the example impression frequency analyzer 200 of FIG. 2 is illustrated in FIG. 2, one or more of the elements, processes and/or devices illustrated in FIG. 2 may be combined, divided, re-arranged, omitted, eliminated and/or implemented in any other way. Further, the example impression information collector 202, the example user-identified impression frequency data analyzer 204, the example multi-dimensional array converter 206, the example constraints analyzer 208, the example numerical analyzer 210, the example report generator 212, and/or, more generally, the example impression frequency analyzer 200 of FIG. 2 may be implemented by hardware, software, firmware and/or any combination of hardware, software and/or firmware. Thus, for example, any of the example impression information collector 202, the example user-identified impression frequency data analyzer 204, the example multi-dimensional array converter 206, the example constraints analyzer 208, the example numerical analyzer 210, the example report generator 212, and/or, more generally, the example impression frequency analyzer 200 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example impression information collector 202, the example user-identified impression frequency data analyzer 204, the example multi-dimensional array converter 206, the example constraints analyzer 208, the example numerical analyzer 210, and/or the example report generator 212 is/are hereby expressly defined to include a tangible computer readable storage device or storage disk such as a memory, a digital versatile disk (DVD), a compact disk (CD), a Blu-ray disk, etc. storing the software and/or firmware. Further still, the example impression frequency analyzer 200 of FIG. 2 may include one or more elements, processes and/or devices in addition to, or instead of, those illustrated in FIG. 2, and/or may include more than one of any or all of the illustrated elements, processes and devices.

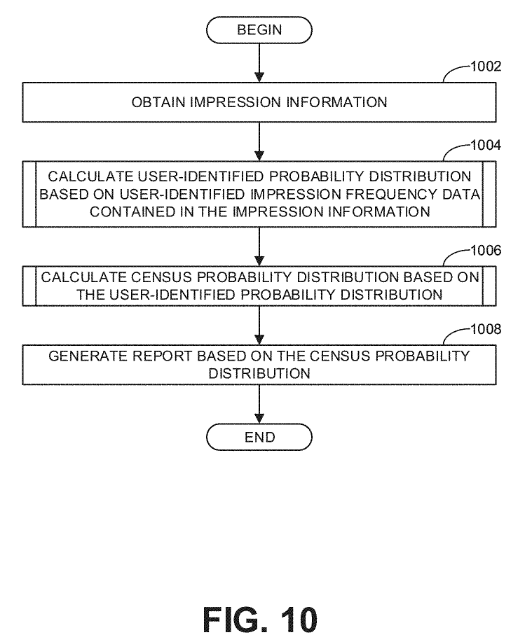

Flowcharts representative of example machine readable instructions for implementing the impression frequency analyzer 200 of FIG. 2 are shown in FIGS. 10-14. In these examples, the machine readable instructions comprise one or more program(s) for execution by a processor such as the processor 1512 shown in the example processor platform 1500 discussed below in connection with FIG. 15. The program(s) may be embodied in software stored on a tangible computer readable storage medium such as a CD-ROM, a floppy disk, a hard drive, a digital versatile disk (DVD), a Blu-ray disk, or a memory associated with the processor 1512, but the entirety of the program(s) and/or parts thereof could alternatively be executed by a device other than the processor 1512 and/or embodied in firmware or dedicated hardware. Further, although the example program(s) are described with reference to the flowcharts illustrated in FIGS. 10-14, many other methods of implementing the example impression frequency analyzer 200 may alternatively be used. For example, the order of execution of the blocks may be changed, and/or some of the blocks described may be changed, eliminated, or combined.

As mentioned above, the example processes of FIGS. 10-14 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 10-14 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

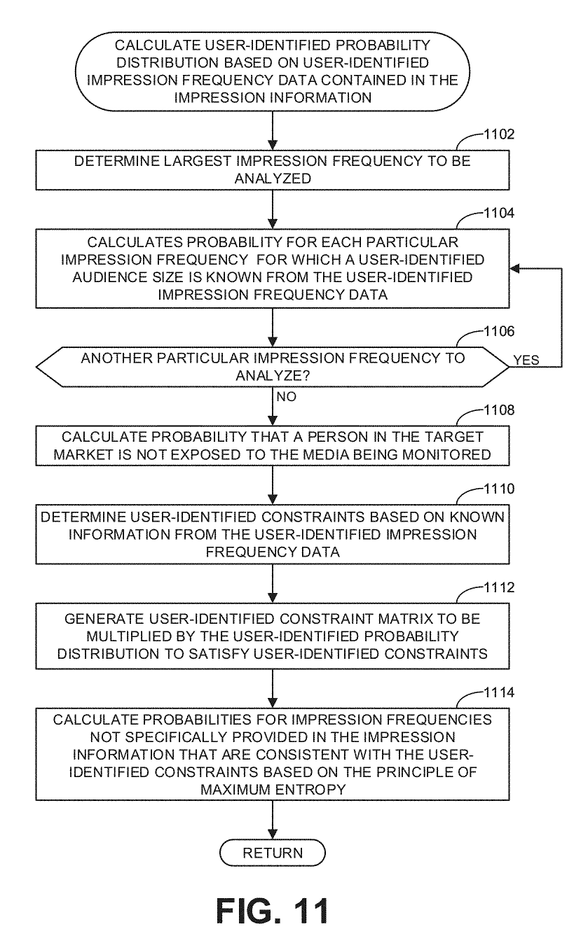

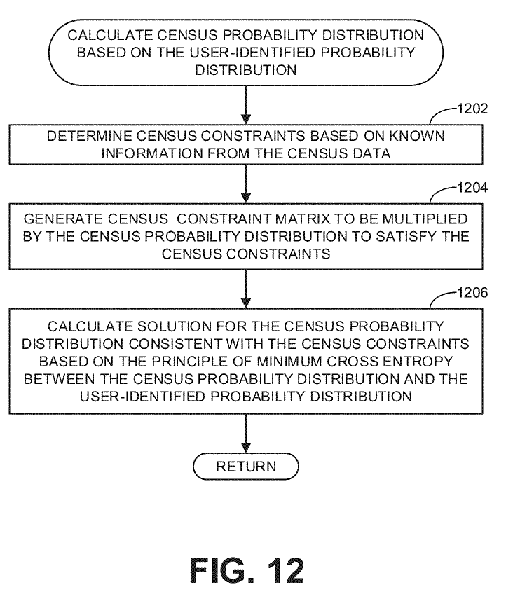

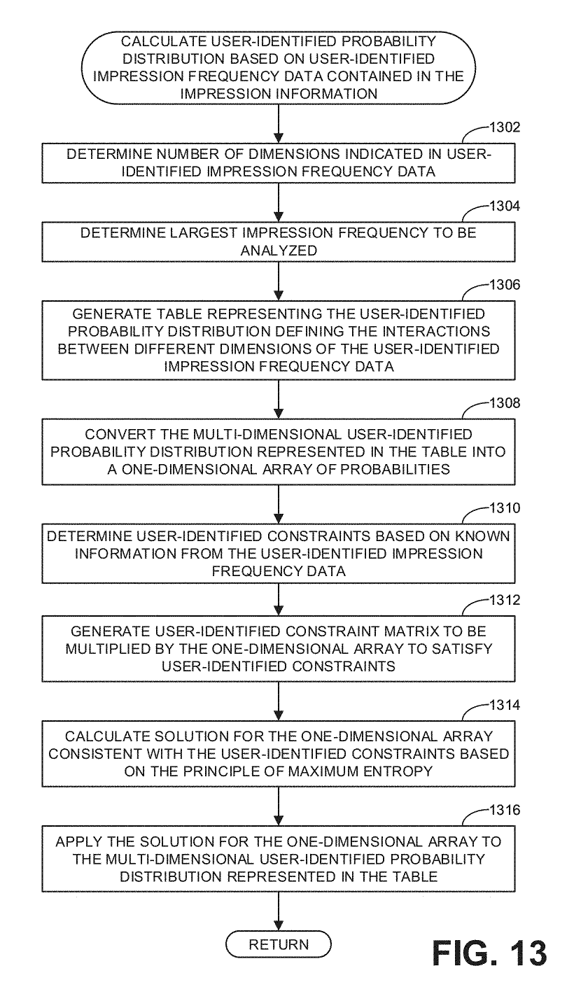

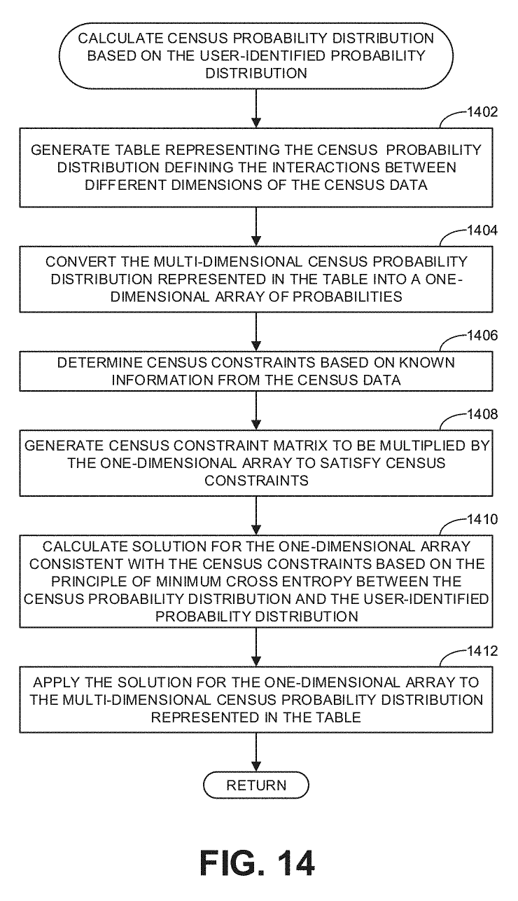

Turning in detail to the flowcharts, the example process of FIG. 10 begins at block 1002 where the example impression information collector 202 (FIG. 2) obtains impression information. At block 1004, the example impression frequency analyzer 200 (FIG. 2) calculates a user-identified probability distribution based on user-identified impression frequency data contained in the impression information. Additional detail regarding the implementation of block 1004 is described below in connection with FIG. 11 for one-dimensional data and FIG. 13 for two-dimensional data. At block 1006, the example impression frequency analyzer 200 calculates a census probability distribution based on the user-identified probability distribution. Additional detail regarding the implementation of block 1006 is described below in connection with FIG. 12 for one-dimensional impression information and FIG. 14 for multi-dimensional impression information. At block 1008, the example report generator 212 (FIG. 2) generates a report based on the census probability distribution.

FIG. 11 is a flowchart representative of example machine readable instructions for implementing block 1004 of FIG. 10 based on one-dimensional impression information (e.g., using impressions collected for PC devices exclusive of mobile devices or collected for mobile devices exclusive of PC devices). The example process begins at block 1102 where the example user-identified impression frequency data analyzer 204 (FIG. 2) determines a largest impression frequency to be analyzed. At block 1104, the example user-identified impression frequency data analyzer 204 calculates a probability for each particular impression frequency for which a user-identified audience size is known from the user-identified impression frequency data. In some examples, the probability is calculated by dividing the user-identified audience size for the particular impression frequency by a total population for the target market of the media being monitored. At block 1106, the example user-identified impression frequency data analyzer 204 determines whether there is another particular impression frequency to analyze. If so, control returns to block 1104. Otherwise, control advances to block 1108.

At block 1108, the example user-identified impression frequency data analyzer 204 (FIG. 2) calculates a probability that a person in the target market is not exposed to the media being monitored. This probability corresponds to the non-reach of the media and may be calculated as the difference between the total population and the total user-identified audience size, and dividing the result by the total population. At block 1110, the example constraints analyzer 208 (FIG. 2) determines user-identified constraints based on known information from the user-identified impression frequency data. At block 1112, the example constraints analyzer 208 generates a user-identified constraint matrix (e.g., the constraint matrix 601 of FIG. 6) to be multiplied by the user-identified probability distribution to satisfy the user-identified constraints. At block 1114, the example numerical analyzer 210 (FIG. 2) calculates probabilities for impression frequencies not specifically provided in the impression information that are consistent with the user-identified constraints based on the principle of maximum entropy. Thereafter, the example process of FIG. 11 ends and control returns to a calling function or process such as the process of FIG. 10.

FIG. 12 is a flowchart representative of example machine readable instructions for implementing block 1006 of FIG. 10 based on one-dimensional impression information (e.g., using impressions collected for PC devices exclusive of mobile devices or collected for mobile devices exclusive of PC devices). That is, the example process of FIG. 12 may follow the completion of FIG. 11 described above. The example process of FIG. 12 begins at block 1202 where the example constraints analyzer 208 (FIG. 2) determines census constraints based on known information from the census data (e.g., the census data 302 of FIG. 3). At block 1204, the example constraints analyzer 208 generates a census constraint matrix (e.g., the census constraint matrix 902 of FIG. 9) to be multiplied by the census probability distribution to satisfy the census constraints. At block 1206, the example numerical analyzer 210 (FIG. 2) calculates a solution for the census probability distribution consistent with the census constraints based on the principle of minimum cross entropy between the census probability distribution and the user-identified probability distribution. For example, the example numerical analyzer 210 sets up the linear system of constraints CP=D similar to what is shown in FIG. 7 to then solve for P. Thereafter, the example process of FIG. 12 ends and returns to complete the process of FIG. 10.

FIG. 13 is a flowchart representative of example machine readable instructions for implementing block 1006 of FIG. 10 based on multi-dimensional impression information (e.g., using impressions collected for PC and mobile devices). The example process begins at block 1302 where the example user-identified impression frequency data analyzer 204 (FIG. 2) determines the number of dimensions indicated in the user-identified impression frequency data. At block 1304, the example user-identified impression frequency data analyzer 204 determines a largest impression frequency to be analyzed. At block 1306, the example multi-dimensional array converter 206 (FIG. 2) generates a table representing the user-identified probability distribution defining the interactions between the different dimensions of the user-identified impression frequency data. At block 1308, the example multi-dimensional array converter 206 converts the multi-dimensional user-identified probability distribution represented in the table into a one-dimensional array of probabilities.

At block 1310, the example constraints analyzer 208 (FIG. 2) determines user-identified constraints based on known information from the user-identified impression frequency data. At block 1312, the example constraints analyzer 208 generates a user-identified constraint matrix to be multiplied by the one-dimensional array to satisfy the user-identified constraints. At block 1314, the example numerical analyzer 210 (FIG. 2) calculates a solution for the one-dimensional array that is consistent with the user-identified constraints based on the principle of maximum entropy. At block, 1316, the example user-identified impression frequency data analyzer 204 applies the solution for the one-dimensional array to the multi-dimensional user-identified probability distribution represented in the table. Thereafter, the example process of FIG. 13 ends and control returns to a calling function or process such as the process of FIG. 10.

FIG. 14 is a flowchart representative of example machine readable instructions for implementing block 1006 of FIG. 10 based on multi-dimensional impression information (e.g., using impressions collected for both PC devices and mobile devices). That is, the example process of FIG. 14 may follow the completion of FIG. 13 described above. The example process of FIG. 14 begins at block 1402 where the example multi-dimensional array converter 206 (FIG. 2) generates a table representing the census probability distribution defining the interactions between the different dimensions of the census data. For example, each probability p1-p14201 in the table 800 of FIG. 8 represents a separate interaction between the dimensions of PC devices and mobile devices. More particularly, the probability p6 corresponds to the interaction between PC and mobile devices in which an individual is exposed to media twice via a PC device and once via a mobile device. At block 1404, the example multi-dimensional array converter 206 converts the multi-dimensional census probability distribution represented in the table into a one-dimensional array of probabilities.

At block 1406, the example constraints analyzer 208 determines census constraints based on known information from the census data. At block 1408, the example constraints analyzer 208 generates a census constraint matrix to be multiplied by the one-dimensional array to satisfy the census constraints. At block 1410, the example numerical analyzer 210 (FIG. 2) calculates a solution for the one-dimensional array that is consistent with the census constraints based on the principle of minimum cross entropy between the census probability distribution and the user-identified probability distribution. At block, 1412, the example user-identified impression frequency data analyzer 204 (FIG. 2) applies the solution for the one-dimensional array to the multi-dimensional census probability distribution represented in the table. Thereafter, the example process of FIG. 14 ends and control returns to a calling function or process such as the process of FIG. 10.

FIG. 15 is a block diagram of an example processor platform 1500 capable of executing the instructions of FIGS. 10-14 to implement the impression frequency analyzer 200 of FIG. 2. The processor platform 1500 can be, for example, a server, a personal computer, a mobile device (e.g., a cell phone, a smart phone, a tablet such as an iPad™), a personal digital assistant (PDA), an Internet appliance, or any other type of computing device.

The processor platform 1500 of the illustrated example includes a processor 1512. The processor 1512 of the illustrated example is hardware. For example, the processor 1512 can be implemented by one or more integrated circuits, logic circuits, microprocessors or controllers from any desired family or manufacturer. The example processor 1512 of FIG. 15 may execute the computer readable instructions 1532 represented in FIGS. 10, 11, 12, 13, and/or 14 to implement the example impression information collector 202, the example user-identified impression frequency data analyzer 204, the example multi-dimensional array converter 206, the example constraints analyzer 208, the example numerical analyzer 210, the example report generator 212, and/or, more generally, the example impression frequency analyzer 200 of FIG. 2.

The processor 1512 of the illustrated example includes a local memory 1513 (e.g., a cache). The processor 1512 of the illustrated example is in communication with a main memory including a volatile memory 1514 and a non-volatile memory 1516 via a bus 1518. The volatile memory 1514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1516 may be implemented by flash memory and/or any other desired type of memory device. Access to the main memory 1514, 1516 is controlled by a memory controller.

The processor platform 1500 of the illustrated example also includes an interface circuit 1520. The interface circuit 1520 may be implemented by any type of interface standard, such as an Ethernet interface, a universal serial bus (USB), and/or a PCI express interface.

In the illustrated example, one or more input devices 1522 are connected to the interface circuit 1520. The input device(s) 1522 permit(s) a user to enter data and commands into the processor 1512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1524 are also connected to the interface circuit 1520 of the illustrated example. The output devices 1524 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1520 of the illustrated example, thus, typically includes a graphics driver card, a graphics driver chip or a graphics driver processor.

The interface circuit 1520 of the illustrated example also includes a communication device such as a transmitter, a receiver, a transceiver, a modem and/or network interface card to facilitate exchange of data with external machines (e.g., computing devices of any kind) via a network 1526 (e.g., an Ethernet connection, a digital subscriber line (DSL), a telephone line, coaxial cable, a cellular telephone system, etc.).

The processor platform 1500 of the illustrated example also includes one or more mass storage devices 1528 for storing software and/or data. Examples of such mass storage devices 1528 include floppy disk drives, hard drive disks, compact disk drives, Blu-ray disk drives, RAID systems, and digital versatile disk (DVD) drives.

Coded instructions 1532 that may be used to implement the machine readable instructions of FIGS. 10-14 may be stored in the mass storage device 1528, in the volatile memory 1514, in the non-volatile memory 1516, and/or on a removable tangible computer readable storage medium such as a CD or DVD.

From the foregoing, it will be appreciated that methods, apparatus and articles of manufacture have been disclosed to enable the estimation of media impression frequency distributions for all impressions (i.e., census impressions) recorded for media being monitored. The total number of census impressions may be determined from monitored information collected in connection with cookies stored on client devices that report access to tagged media. While the cookie information may enable the number of impressions associated with each cookie (e.g., a cookie frequency), there is no way to directly determine the number of impressions corresponding to specific individuals because one or more of the cookies may be associated with the same person. Database proprietors may contain user profile information tied to specific cookie information such that specific individuals can be matched to particular impressions of media. However, at least some portion of the media audience is likely to correspond to individuals who the database proprietor is unable to recognize. Examples disclosed herein overcome this issue to estimate an impression frequency distribution for media across all individuals of an audience based on a user-identified frequency distribution corresponding to person that the database proprietor recognizes. Direct linear scaling from the user-identified impressions to census-wide impressions may not be valid. As such, in some examples, the user-identified impression frequency data is used as prior information to calculate the census impression frequency distribution based on the principle of minimum cross-entropy.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A media monitoring device of an audience measurement entity, comprising:
an impression information collector to:
obtain requests from computing devices indicative of accesses to media at the computing devices, a total count of the requests corresponding to a total number of census impressions associated with the media; and
obtain a first impression frequency distribution from a database proprietor, the first impression frequency distribution corresponding to user-identified impressions of the census impressions and exclusive of unidentified impressions of the census impressions, the user-identified impressions corresponding to user-identified individuals for whom first demographic information is stored by the database proprietor, the first impression frequency distribution including a plurality of impression frequency groups of user-identified audience sizes, ones of the impression frequency groups representative of user-identified individuals that accessed the media a corresponding number numbers of times; and
a user-identified impression frequency data analyzer to determine a second impression frequency distribution for the user-identified impressions and the unidentified impressions of the census impressions based on the first impression frequency distribution.

2. The media monitoring device of claim 1, wherein the user-identified impression frequency data analyzer is to determine a total census audience size corresponding to the total number of census impressions based on the second impression frequency distribution.

3. The media monitoring device of claim 1, wherein the user-identified impression frequency data analyzer is to determine the second impression frequency distribution by:
calculating a user-identified probability distribution based on the first impression frequency distribution; and
calculating a census probability distribution that satisfies the principle of minimum cross entropy between the census probability distribution and the user-identified probability distribution consistent with census constraints defined by census data associated with the census impressions, the census probability distribution including probability values for corresponding frequencies in the second impression frequency distribution.

4. The media monitoring device of claim 3, wherein the user-identified probability distribution directly corresponds to the first impression frequency distribution.

5. The media monitoring device of claim 3, wherein the user-identified impression frequency data analyzer is to calculate the user-identified probability distribution based on the first impression frequency distribution by calculating probability values in the user-identified probability distribution that are consistent with user-identified constraints and that satisfy the principle of maximum entropy.

6. The media monitoring device of claim 5, wherein the user-identified impression frequency data analyzer is to calculate the probability values in the user-identified probability distribution that satisfy the principle of maximum entropy by determining a maximum of the negative of a summation of each probability value in the user-identified probability distribution multiplied by the log of a ratio of each corresponding probability value in the user-identified probability distribution.

7. The media monitoring device of claim 5, further including a constraints analyzer to generate a user-identified constraint matrix that, when multiplied by the user-identified probability distribution represented as a one-dimensional array of the probability values arranged in a first column matrix, equals a second column matrix containing user-identified constraint values defined by the user-identified constraints.

8. The media monitoring device of claim 7, wherein the user-identified probability distribution represents interrelationships between different dimensions of the user-identified impressions, the one-dimensional array of the probability values based on a relabeling of entries in a multi-dimensional array representing interrelationships between the different dimensions.

9. The media monitoring device of claim 3, wherein the user-identified impression frequency data analyzer is to calculate the census probability distribution that satisfies the principle of minimum cross entropy by determining a minimum of a summation of each probability value in the census probability distribution multiplied by the log of a ratio of each corresponding probability value in the census probability distribution to each corresponding probability value in the user-identified probability distribution.

10. The media monitoring device of claim 3, further including a constraints analyzer to generate a census constraint matrix that, when multiplied by the census probability distribution represented as a one-dimensional array of the probability values arranged in a first column matrix, equals a second column matrix containing census constraint values defined by the census constraints.

11. The media monitoring device of claim 3, wherein the census probability distribution represents interrelationships between different dimensions of the census impressions.

12. The media monitoring device of claim 11, wherein the different dimensions correspond to at least one of different platforms of the computing devices, different Internet sites through which the media was accessed, different geographic locations where the media was accessed, or different placements or formats of the media within websites through which the media was accessed.

13. The media monitoring device of claim 1, wherein a difference between a first number of the user-identified impressions and the total number of census impressions corresponds to a second number of the unidentified impressions, the unidentified impressions associated with unidentified individuals for whom second demographic information is not stored by the database proprietor.

14. The media monitoring device of claim 1, wherein at least one of the impressions information collector or the user identified impression frequency analyzer is implemented by a hardware processor.

15. A method, comprising:
logging a plurality of requests in a database, the plurality of requests obtained from a plurality of network communications from computing devices, the plurality of requests indicative of accesses to media at the computing devices, a total count of the requests corresponding to a total number of census impressions associated with the media;
obtaining a first impression frequency distribution from a database proprietor, the first impression frequency distribution corresponding to user-identified impressions of the census impressions and exclusive of unidentified impressions of the census impressions, the user-identified impressions corresponding to user-identified individuals for whom first demographic information is stored by the database proprietor, the first impression frequency distribution including a plurality of impression frequency groups of user-identified audience sizes, ones of the impression frequency groups representative of user-identified individuals that accessed the media a corresponding number numbers of times; and
determining, by executing an instruction with a processor, a second impression frequency distribution for the user-identified impressions and the unidentified impressions of the census impressions based on the first impression frequency distribution.

16-27. (canceled)

28. A tangible computer readable storage medium comprising instructions that, when executed, cause a machine to at least:
log a plurality of requests in a database, the plurality of requests obtained from a plurality of network communications from computing devices, the plurality of requests indicative of accesses to media at the computing devices, a total count of the requests corresponding to a total number of census impressions associated with the media;
obtain a first impression frequency distribution from a database proprietor, the first impression frequency distribution corresponding to user-identified impressions of the census impressions and exclusive of unidentified impressions of the census impressions, the user-identified impressions corresponding to user-identified individuals for whom first demographic information is recognizable by the database proprietor, the first impression frequency distribution including a plurality of impression frequency groups of user-identified audience sizes, ones of the impression frequency groups representative of user-identified individuals that accessed the media a corresponding number numbers of times; and
determine a second impression frequency distribution for the user-identified impressions and the unidentified impressions of the census impressions based on the first impression frequency distribution.

29. (canceled)

30. The storage medium of claim 28, wherein the determining of the second impression frequency distribution includes:
calculating a user-identified probability distribution based on the first impression frequency distribution; and
calculating a census probability distribution that satisfies the principle of minimum cross entropy between the census probability distribution and the user-identified probability distribution consistent with census constraints defined by census data associated with the census impressions, the census probability distribution including probability values for corresponding frequencies in the second impression frequency distribution.

31. (canceled)

32. The storage medium of claim 30, wherein the instructions further cause the machine to calculate probability values in the user-identified probability distribution that are consistent with user-identified constraints and that satisfy the principle of maximum entropy.

33. (canceled)

34. The storage medium of claim 32, wherein the instructions further cause the machine to generate a user-identified constraint matrix that, when multiplied by the user-identified probability distribution represented as a one-dimensional array of the probability values arranged in a first column matrix, equals a second column matrix containing user-identified constraint values defined by the user-identified constraints.

35. (canceled)

36. (canceled)

37. The storage medium of claim 30, wherein the instructions further cause the machine to generate a census constraint matrix that, when multiplied by the census probability distribution represented as a one-dimensional array of the probability values arranged in a first column matrix, equals a second column matrix containing census constraint values defined by the census constraints.

38-48. (canceled)
